(19) United States
(12) Patent Application Publication
(10) Pub. No.: US 2014/0316456 A1
(43) Pub. Date: Oct. 23, 2014

(54) EAR STIMULATING APPARATUS

(71) Applicant: Panasonic Corporation, Osaka (JP)

(72) Inventor: Takeshi ANDO, Kyoto (JP)

(73) Assignee: Panasonic Corporation, Osaka (JP)

(21) Appl. No.: 14/256,114

(22) Filed: Apr. 18, 2014

(30) Foreign Application Priority Data
Apr. 23, 2013 (JP) 2013-089963
Jul. 11, 2013 (JP) 2013-145213
Mar. 18, 2014 (JP) 2014-055066

(51) Int. Cl. A61H 39/04

(52) U.S. Cl. CPC A61H 39/04
USPC 606/204

(57) ABSTRACT

An ear stimulating apparatus includes first and second units capable of clipping on an auricle and gripping an ear, a plurality of contacts arranged in the first unit at least at positions where the contacts are capable of being brought into contact with a front side of the auricle, and an actuator that moves the contacts in the longitudinal direction of the first unit.

### TECHNICAL FIELD

The present invention relates to an ear stimulating apparatus that stimulates a human ear.

### BACKGROUND ART

It is said that there are 100 or more acupressure points in a human ear. For the purpose of relieving fatigue or swelling, an apparatus that presses an ear is proposed. For example, there is an ear stimulating apparatus in which contacts are reciprocated toward acupressure points of an ear (for example, refer to Patent Literature 1).

FIG. 27 is a configuration view of the conventional ear stimulating apparatus disclosed in Patent Literature 1. The conventional ear stimulating apparatus 1 is worn on an ear by a fastener 2. The conventional ear stimulating apparatus 1 includes a vibration terminal 3 to be brought into contact with an acupressure point of the ear, and a vibration device 4 for reciprocating the vibration terminal 3 toward an auricle. The auricle is an externally projecting part of a human ear.

Although not for an ear, there is proposed a massage chair in which by cancelling driving noise of the massage chair and streaming music, a physically-sensed influence of the driving noise is reduced (for example, refer to Patent Literature 2).

FIG. 26 is a configuration view of the conventional massage chair disclosed in Patent Literature 2. The conventional massage chair 10 includes an electric machine portion 11a and also a sensor 12 that detects vibration information of the electric machine portion 11a. A speaker 14 and a monitor microphone 15 are provided in an upper part of the massage chair 10. A sound generation device 13 that generates sound from the speaker 14 is provided in the upper part of the massage chair 10. The massage chair 10 cancels the driving noise of the electric machine portion 11a with the sound generated from the speaker 14, so as to eliminate discomfort feeling due to the driving noise and further improve a relaxing effect by massage.

### CITATION LIST

### Patent Literature

Patent Literature 1: Japanese Unexamined Patent Publication No. 2000-167019
Patent Literature 2: Japanese Unexamined Patent Publication No. H05-84268

### SUMMARY OF THE INVENTION

However, the conventional ear stimulating apparatus only gives a static force or vibration to the auricle in the perpendicular direction. Therefore, with the conventional ear stimulating apparatus, a case where stimulation to the ear is insufficient is possibly generated.

An object of the present invention is to provide an ear stimulating apparatus capable of improving stimulation to an ear.

In order to accomplish the above object, according to one aspect of the present invention, there is provided an ear stimulating apparatus comprising:

first and second units arranged to clip on an auricle;

a plurality of contacts arranged in the first unit least at positions where the contacts are configured to be brought into contact with a front side of the auricle; and

an actuator that moves the contacts in a longitudinal direction of the first unit.

As described above, according to the ear stimulating apparatus of the aspect of the present invention, an effect of stimulating the ear can be improved in comparison to the conventional example.

### BRIEF DESCRIPTION OF THE DRAWINGS

These and other objects and features of the present invention will become clear from the following description taken in conjunction with the embodiments thereof with reference to the accompanying drawings, in which:

FIG. 1A is a configuration view of an ear stimulating apparatus in a first embodiment of the present invention;

FIG. 1B is a schematic view for illustrating parts of an auricle;

FIG. 1C is a partial top view of the ear stimulating apparatus in the first embodiment of the present invention;

FIG. 1D is a partial top view of an ear stimulating apparatus in a first modified example of the first embodiment of the present invention;

FIG. 2A is a schematic view showing a leading end of a contact of the ear stimulating apparatus in the first embodiment of the present invention;

FIG. 2B is a schematic view showing a leading end of a contact of the ear stimulating apparatus in the first embodiment of the present invention;

FIG. 2C is a schematic view showing a leading end of a contact of the ear stimulating apparatus in the first embodiment of the present invention;

FIG. 2D is a schematic view showing a leading end of a contact of the ear stimulating apparatus in the first embodiment of the present invention;

FIG. 3A is a schematic view of a fastener-integrated form of the ear stimulating apparatus in the first embodiment;

FIG. 3B is a partial top view of the fastener-integrated form of the ear stimulating apparatus in the first embodiment;

FIG. 4A is a schematic view for illustrating a mechanism of the ear stimulating apparatus in the first embodiment at the time of belt drive;

FIG. 4B is a partial top view for illustrating the mechanism of the ear stimulating apparatus in the first embodiment at the time of the belt drive;

FIG. 5A is a schematic view for illustrating a mechanism of the ear stimulating apparatus in the first embodiment at the time of upper and lower link drive;

FIG. 5B is a partial top view for illustrating the mechanism of the ear stimulating apparatus in the first embodiment at the time of the upper and lower link drive;

FIG. 6A is a schematic view for illustrating a mechanism of the ear stimulating apparatus in the first embodiment at the time of left and right link drive;

FIG. 6B is a partial top view for illustrating the mechanism of the ear stimulating apparatus in the first embodiment at the time of the left and right link drive;

FIG. 7A is a schematic view for illustrating a mechanism of the ear stimulating apparatus in the first embodiment at the time of pressing drive;

FIG. 7B is a partial top view for illustrating the mechanism of the ear stimulating apparatus in the first embodiment at the time of the pressing drive;

FIG. 8A is a partial top view for illustrating movement when an auricle is bent by using the ear stimulating apparatus in the first embodiment;

FIG. 8B is a view in which the auricle is seen from a front surface, the view for illustrating the movement when the auricle is bent by using the ear stimulating apparatus in the first embodiment;

FIG. 8C is a view in which the auricle is seen from a rear head part, the view for illustrating the movement when the auricle is bent by using the ear stimulating apparatus in the first embodiment;

FIG. 9A is a partial top view for illustrating movement when the auricle is largely bent by using the ear stimulating apparatus in the first embodiment;

FIG. 9B is a view in which the auricle is seen from the front surface, the view for illustrating the movement when the auricle is largely bent by using the ear stimulating apparatus in the first embodiment;

FIG. 9C is a view in which the auricle is seen from the rear head part, the view for illustrating the movement when the auricle is largely bent by using the ear stimulating apparatus in the first embodiment;

FIG. 10A is a view showing a face temperature before using the ear stimulating apparatus of the first embodiment;

FIG. 10B is a view showing a face temperature after using the ear stimulating apparatus of the first embodiment;

FIG. 11A is a view showing arrangement of contacts of the ear stimulating apparatus in a first example of an operation of the first embodiment;

FIG. 11B is a schematic view of the time of up and down movement of the contacts in the first example of the operation of the first embodiment;

FIG. 11C is a schematic view of the time of left and right movement of the contacts in the first example of the operation of the first embodiment;

FIG. 12A is a view showing arrangement of the contacts of the ear stimulating apparatus in a second example of the operation of the first embodiment;

FIG. 12B is a view for illustrating the lowering order of the contacts in the second example of the operation of the first embodiment;

FIG. 12C is a view for illustrating the rising order of the contacts in the second example of the operation of the first embodiment;

FIG. 13 is a schematic view of a configuration of the ear stimulating apparatus for realizing the second example of the operation of the first embodiment;

FIG. 14A is a view showing arrangement of the contacts in a third example of the operation of the first embodiment;

FIG. 14B is a view for illustrating the moving direction of the contacts in the third example of the operation of the first embodiment;

FIG. 15A is a view of movement of the contacts when the ear stimulating apparatus is utilized in a fourth example of the operation of the first embodiment, the view showing the moving direction of the contacts from an upper part of the auricle;

FIG. 15B is a view of movement of the contacts when the ear stimulating apparatus is utilized in the fourth example of the operation of the first embodiment, the view showing the moving direction of the contacts from a front surface of the auricle;

FIG. 16A is a schematic view of the ear stimulating apparatus in a fifth example of the operation of the first embodiment, the view showing the moving direction of the contacts from the upper part of the auricle;

FIG. 16B is schematic view of the ear stimulating apparatus in the fifth example of the operation of the first embodiment, the view showing the moving direction of the contacts from the front surface of the auricle;

FIG. 16C is a schematic view of the ear stimulating apparatus in the fifth example of the operation of the first embodiment, the schematic view being seen from the upper part of the auricle;

FIG. 16D is a schematic view of the ear stimulating apparatus in the fifth example of the operation of the first embodiment, the schematic view being seen from the front surface of the auricle;

FIG. 17A is a front view of an ear stimulating apparatus in a modified example of the first embodiment;

FIG. 17B is a right side view of the ear stimulating apparatus of FIG. 17A;

FIG. 17C is a back view of the ear stimulating apparatus of FIG. 17A;

FIG. 17D is an illustrative view of a state where the ear stimulating apparatus of FIG. 17A is worn on an ear;

FIG. 18 is an entire configuration view of an ear stimulating apparatus in a second embodiment of the present invention;

FIG. 19 is a partial configuration view of the ear stimulating apparatus in the second embodiment of the present invention;

FIG. 20 is a schematic view for illustrating parts of the auricle;

FIG. 21 is a partial top view of the ear stimulating apparatus in the second embodiment of the present invention;

FIG. 22A is a flowchart of an ear stimulating method in the second embodiment of the present invention;

FIG. 22B is a flowchart of the ear stimulating method in the second embodiment of the present invention;

FIG. 23 is a graph of a relationship between a music volume level and actuator torque in the second embodiment of the present invention;

FIG. 24A is a Bode plot graphing gain and frequency in the second embodiment of the present invention;

FIG. 24B is a Bode plot graphing phase lag and frequency in the second embodiment of the present invention;

FIG. 25A is a graph of one example of a relationship between volume level and time;

FIG. 25B is a graph of one example of a relationship between torque and time;

FIG. 26 is a configuration view showing a massage chair of Patent Literature 2; and

FIG. 27 is a view showing a conventional ear stimulating apparatus described in Patent Literature 1.

### DESCRIPTION OF THE EMBODIMENTS

Hereinafter, embodiments of the present invention will be described with reference to the drawings. It should be noted that the same constituent elements will be given the same reference signs, and description thereof will sometimes be omitted. For easy understanding, the drawings are schematic focusing on the respective constituent elements. It should be noted that in the drawings, X, Y, Z axes are described according to need for clarifying respective corresponding relationships.

### First Embodiment

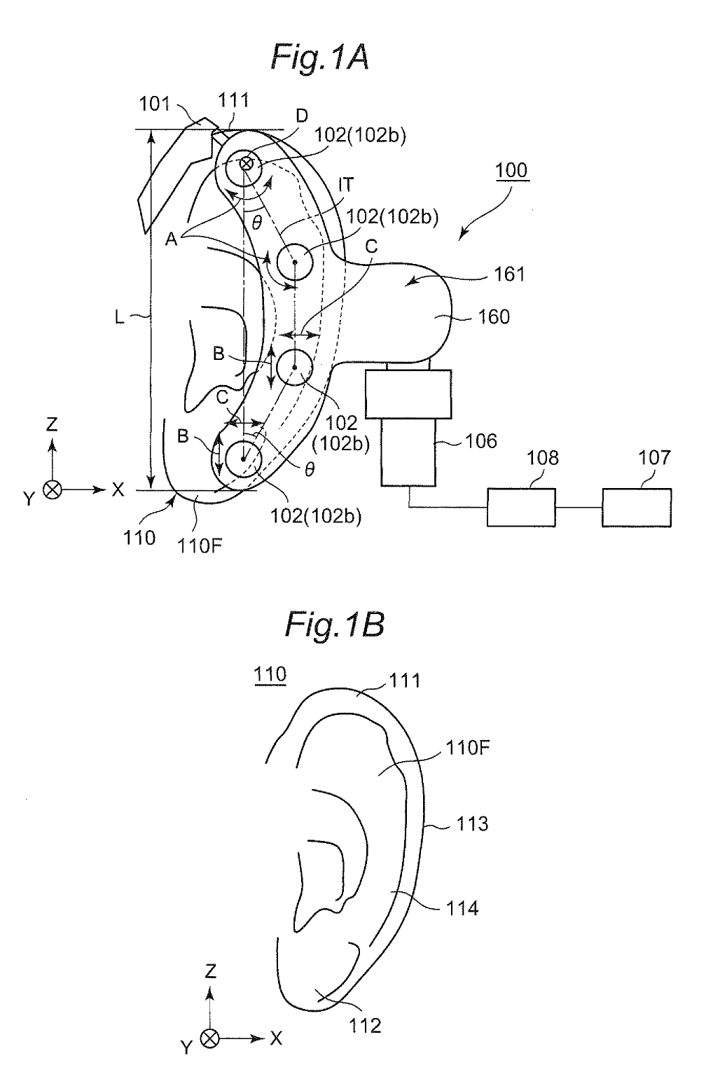

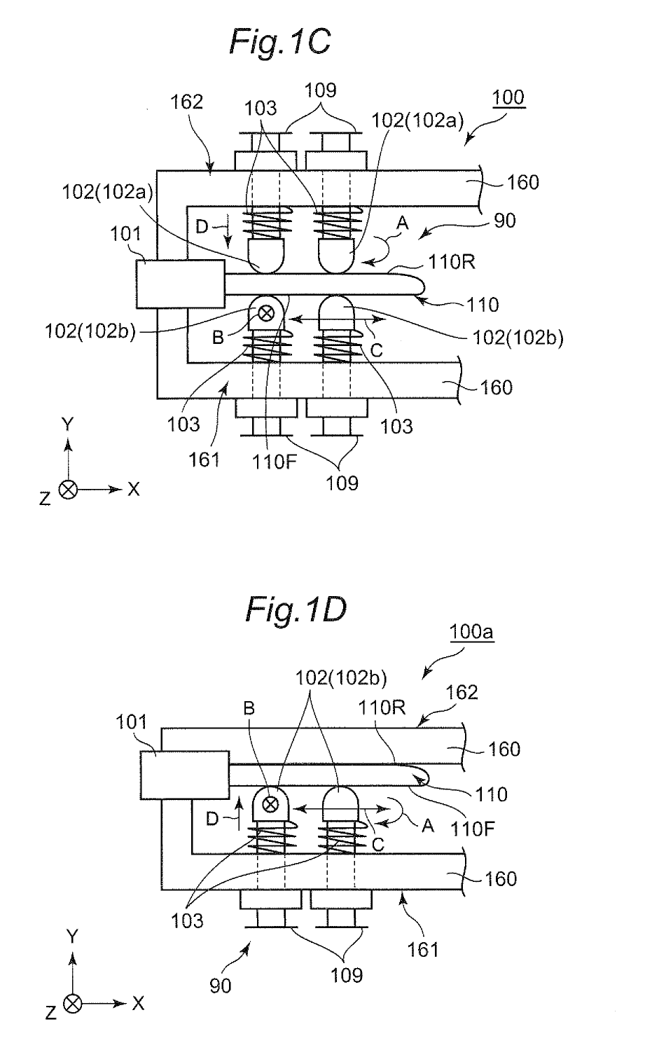

FIGS. 1A to 1D are schematic views of an ear stimulating apparatus 100 in a first embodiment of the present invention. It should be noted that in the first embodiment, contacts 102 are indicated not by dotted lines but by solid lines. This is to make arrangement of the contacts 102 easily understood. Actual contacts 102 are arranged inside a case 160 forming an outer shell of the ear stimulating apparatus 100 and not exposed to the surface.

The ear stimulating apparatus 100 of the first embodiment includes at least a first unit 161, a second unit 162, the plurality of contacts 102, an actuator 106, and a first control unit 30. The first unit 161 and the second unit 162 can grip an ear by clipping on an auricle 110 of a human ear. The plurality of contacts 102 is arranged in the first unit 161 at least at positions where the contacts can be brought into contact with a front side 110F of the auricle 110. The contacts 102 on the front side 110F of the auricle 110 serve as contacts 102b, and the contacts 102 on a back side 110R of the auricle 110 serve as contacts 102a. The auricle 110 is a part externally projecting from a side surface of a face in the ear. The front side 110F of the auricle 110 is a facial side of the auricle 110 (outer side, the side shown in FIG. 1B), and the back side 110R of the auricle 110 is a rear head side of the auricle 110 (inner side). The actuator 106 is an electric motor or the like that moves the contacts 102 at least in the longitudinal direction (up and down direction B in FIG. 1A) of the first unit 161. Various operations of the ear stimulating apparatus 100 are controlled by the first control unit 30.

The ear stimulating apparatus 100 further includes a power supply 107, a switch 108, and a first transfer member 90. The power supply 107 operates the actuator 106. The switch 108 controls ON/OFF of an electric signal from the power supply 107 to the actuator 106. The first transfer member 90 is, for example, a contact drive force transfer member that transfers a drive force generated in the actuator 106 to the contacts 102.

As shown in FIGS. 1A and 1C, the ear stimulating apparatus 100 of the first embodiment (similar to an ear stimulating apparatus 100b to be described later) is characterized in that four contacts 102 (four contacts 102b and four contacts 102a) are respectively provided in the units 161 and 162. The four contacts 102b and the four contacts 102a are respectively brought into contact with the front side 110F and the back side 110R of the auricle 110. Details will be described later.

An ear stimulating apparatus 100a shown in FIG. 1D is a first modified example of the first embodiment and an apparatus of the simplest configuration in the first embodiment. As shown in FIG. 1D, this apparatus is characterized in that a first unit 161 has at least two contacts 102b. In a case of this first modified example, a second unit 162 is not provided with contacts 102a but comes into contact with the back side 110R of the auricle 110. This ear stimulating apparatus 100a of the first modified example stimulates only the front side 110F of a human ear but can easily be formed.

In the ear stimulating apparatus 100, the first unit 161 is arranged so as to cover a part of the front side 110F of the auricle 110, and the second unit 162 is arranged so as to cover a part of the back side 110R of the auricle 110. The first unit 161 and the second unit 162 are coupled by a coupling member such as a hinge.

The switch 108 is installed on a surface of the case 160 forming the outer shell of the first unit 161 or the second unit 162 of the ear stimulating apparatus 100. As a function of the switch 108, there is a function of controlling ON/OFF of the electric signal from the power supply 107 to the actuator 106. It should be noted that in a case where the ear stimulating apparatus 100 can select various operations to be described below, a function for performing the selection may be provided as a function of the switch 108.

The ear stimulating apparatus 100 also includes the first transfer member 90 in the case 160 of the first unit 161 and the second unit 162. The first transfer member 90 includes, for example, elastic bodies 103, first pulleys 109, and a belt 104. The elastic bodies 103 are springs or the like arranged between the case 160 and leading ends of the contacts 102 and for applying forces toward the auricle 110 to the contacts 102. The first pulleys 109 drive and forward/reversely rotate the contacts 102. The belt 104 drives and forward/reversely rotate the first pulleys 109. The first transfer member 90 transfers the force from the actuator 106 to the contacts 102.

It should be noted that the following description will be given of a case where the contacts 102 are respectively moved by the actuator 106. However, the plurality of contacts 102 may be formed to be interlocked with each other, and the plurality of contacts 102 is interlocked with each other by driving one contact 102 by one actuator 106, so that the plurality of contacts 102 is moved in a similar manner. Thereby, the ear stimulating apparatus 100 can be realized to be inexpensive and lightweight.

As described above, the ear stimulating apparatus 100 in the first embodiment of the present invention is an apparatus that stimulates the auricle 110 by using the four contacts 102b and the four contacts 102a respectively provided in the units 161 and 162 as one example. In this ear stimulating apparatus 100, the plurality of contacts 102 is moved so as to realize an operation of rubbing the entire auricle 110 or an operation of temporarily deforming the auricle 110.

The operations of the contacts 102 of the ear stimulating apparatus 100 of the first embodiment will be described in detail. One example of the operations of the contacts 102 is a first operation of performing an operation of rubbing the auricle 110 at least in the up and down direction (reciprocating operation in the arrow B direction of FIG. 1A) as shown in FIG. 1A. Other examples of the operations of the contacts 102 are, as shown in FIG. 1A, a second operation of performing an operation of twisting the auricle 110 (forward/reverse rotation operation in the circular direction of the arrow A direction of FIG. 1A), a third operation of performing an operation of rubbing the auricle 110 in the front and back direction (reciprocating operation in the arrow C direction of FIG. 1A), and a fourth operation serving as an operation of interlocking the plurality of contacts 102 with each other and temporarily deforming the auricle 110 (operation in the arrow D direction of FIG. 1C). The ear stimulating apparatus 100 of the first embodiment stimulates the auricle 110 by performing the first to fourth operations separately or in appropriate combination in order to increase blood flow of a human face or the like. By such first to fourth operations, the ear stimulating apparatus 100 of the first embodiment has a possibility of thoroughly stimulating many acupressure points in the auricle 110 to enhance the parasympathetic nervous system. That is, the ear stimulating apparatus 100 of the first embodiment not only directly presses and stimulates the acupressure points of the auricle 110 but also utilizes friction or temporary deformation of the auricle 110 to indirectly stimulate the acupressure points of the auricle 110. The first operation (reciprocating operation in the arrow B direction of FIG. 1A) and the third operation (reciprocating operation in the arrow C direction of FIG. 1A) are the directions respectively substantially parallel to a front surface of the auricle 110. The front surface of the auricle 110 indicates a plane including a line that connects one point of an upper end of the front surface of the auricle 110 and one point of a lower end thereof. The direction perpendicular to the front surface of the auricle 110 indicates the direction perpendicular to the plane including the line. It should be noted that the front and back direction (arrow C direction of FIG. 1A) is one example of the direction crossing the longitudinal direction (up and down direction B in FIG. 1A) of the first unit 161. The left and right direction (arrow D direction of FIG. 1A) is one example of the direction crossing the longitudinal direction (up and down direction B in FIG. 1A) of the first unit 161.

In general, as shown in FIG. 1B, the auricle 110 includes an apex auriculae 111 of an upper part, an earlobe 112 of a lower part, a helix 113, and an antihelix 114 of a center part.

As shown in FIG. 1A, the ear stimulating apparatus 100 of the first embodiment is put on the ear by clipping on the apex auriculae 111 of the upper part of the auricle 110 by a clip-shape fastener 101. The clip-shape fastener 101 is arranged in an upper end of the pair of units, that is, the first unit 161 and the second unit 162. The ear stimulating apparatus 100 of the first embodiment stimulates the ear by operating the contacts 102 in contact with the auricle 110 in a state where the ear stimulating apparatus is put on a part of the auricle 110 by the fastener 101.

Arrangement positions of the contacts 102 in a state where the ear stimulating apparatus is put on the auricle 110 by the fastener 101 are desirably positions on the acupressure points of the auricle 110. However, the positions are only required to be positions where the contacts cover a first region of the ear along the helix 113 or the antihelix 114. The first region in the first embodiment is a region ranging from a periphery of the apex auriculae 111 of the upper part of the auricle 110 to the earlobe 112 of the lower part of the auricle 110, the region of 50 mm or more and 70 mm or less. One example of arrangement of the contacts 102 is arrangement in which each of the first unit 161 and the second unit 162 is composed of the four contacts 102 arranged at four vertices of an isosceles trapezoid (see a trapezoid IT indicated by alternate long and short dashed lines in FIG. 1A). One example of a base angle θ of the isosceles trapezoid is 15°≦θ≦30°.

As one example of a size of the first unit 161 and the second unit 162, a longitudinal size L of each of the units is 10 mm≦L≦20 mm. It should be noted that in a case of the above ear stimulating apparatus 100a, the longitudinal size L of the first unit 161 in which the contacts 102 are arranged may be 100 mm≦L≦200 mm, and the second unit 162 may have arbitrary length so as to support movement of the contacts 102 of the first unit 161.

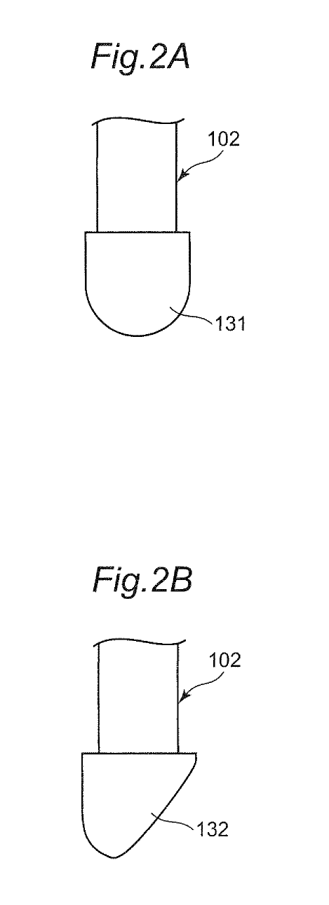

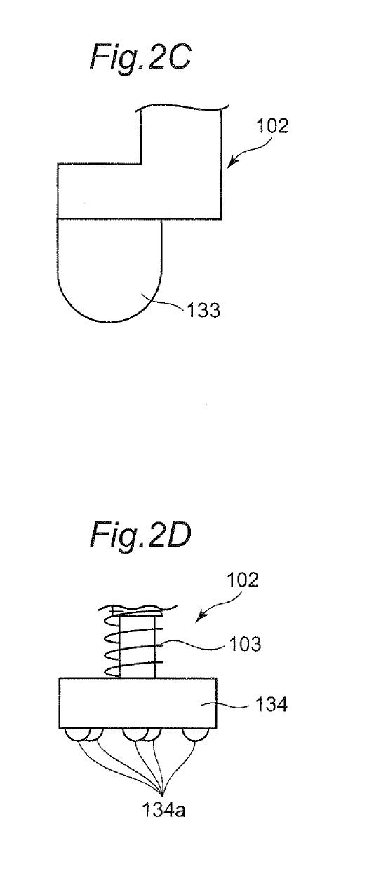

As shown in FIGS. 2A to 2D, a shape of the leading end of each of the contacts 102 is desirably a semispherical shape, so that the leading end can be brought into gentle contact with the auricle 110 to rub the auricle 110. A material of the leading end of the contact 102 is desirably a soft material such as rubber or soft resin. The leading end of the contact 102 is desirably, for example, a semispherical member having a radius of 3 mm or more and 5 mm or less. One example of the leading end of the contact 102 includes a semispherical leading end 131 as in FIG. 2A, an eccentric leading end 132 as in FIG. 2B, or a leading end 133 as in FIG. 2C. The leading end 133 as in FIG. 2C is brought into contact with the auricle 110 by a link or the like at a position different from an extension line of an axis of the first pulley 109. As one example of the leading end of the contact 102, as shown in FIG. 2D, a plurality of semispherical projections 134a may be arranged in a circumferential form on a front surface of a circular plate part of a leading end 134 of the contact 102 in such a manner that a large number of stimulations are given by one contact 102 at the same time.

It should be noted that when the leading ends 131, 132, 133, or 134 of the contacts 102 are detachably formed, the contacts 102 can be replaced or cleaned to be hygienic.

It should be noted that at least two or more contacts 102 are required in the first unit 161. However, in order to temporarily deform the auricle 110 as described later, three or more contacts 102 to be brought into contact with the front side of the auricle 110 are desirably provided in the first unit 161 and three or more contacts 102 to be brought into contact with the back side are desirably provided in the second unit 162.

It should be noted that in the first embodiment, in a case where the contacts 102 on the front and back sides of the auricle 110 are distinguished in the description, the contacts 102 arranged on the front side 110F of the auricle 110 are the contacts 102b, and the contacts 102 arranged on the back side 110R of the auricle 110 are the contacts 102a.

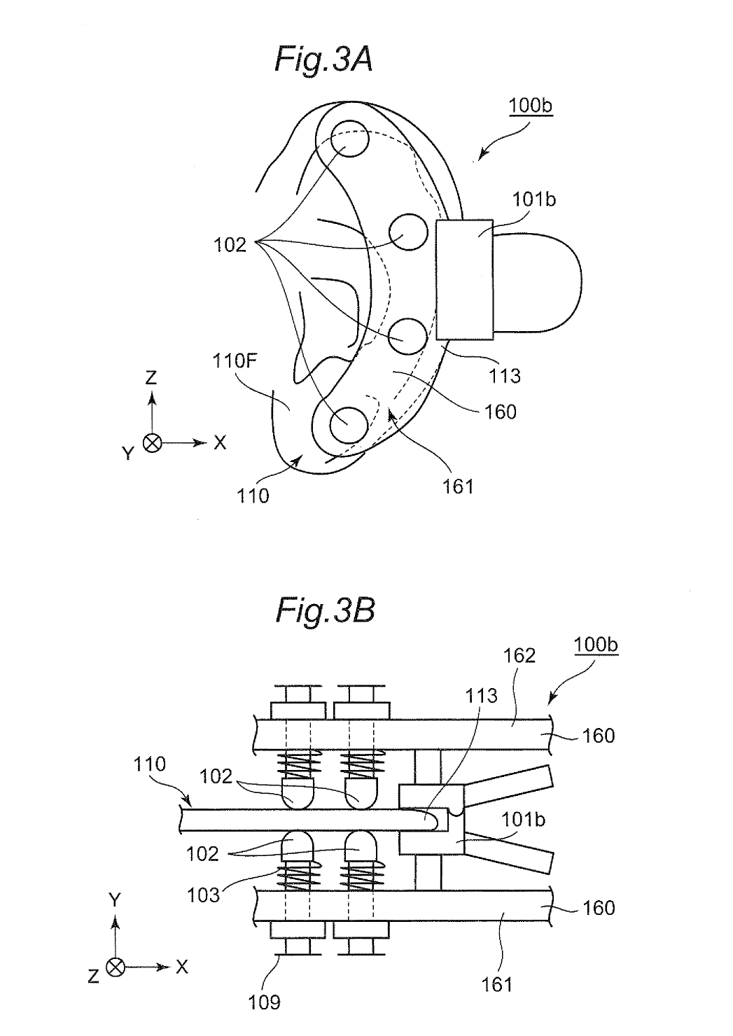

It should be noted that the fastener of the ear stimulating apparatus 100 is not limited to the fastener 101 shown in FIGS. 1A and 1C but a fastener 101b shown in FIGS. 3A and 3B may be used. The fastener 101b is formed so as to open and close the first unit 161 and the second unit 162 in a clip manner, and fixes the ear stimulating apparatus 100 to the ear by clipping on a vicinity part of the helix 113 (side part of the auricle 110) with the first unit 161 and the second unit 162. By using such a fastener 101b, the ear stimulating apparatus 100b can be put on the auricle 110 with a single operation of clipping on the vicinity part of the helix 113.

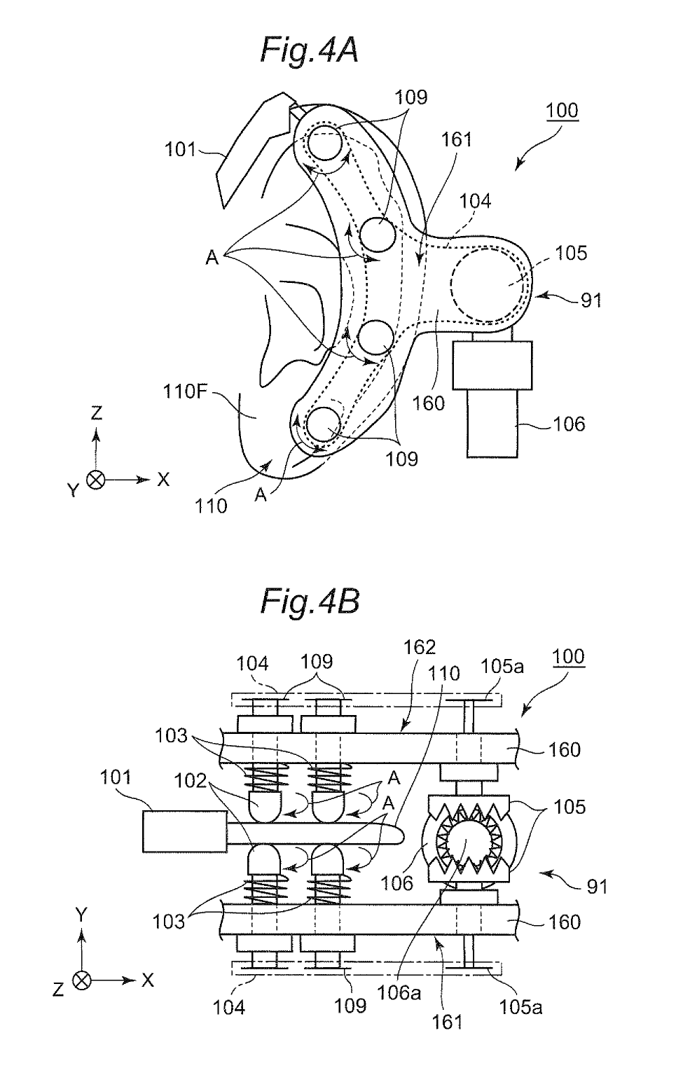

Successively, the first transfer member 90 for realizing the operations of the contacts 102 along the arrows A to D shown in FIG. 1A will be described with reference to FIGS. 4A to 7B. The first transfer member 90 includes, for example, a first mechanism 91 serving as a rotation mechanism, a second mechanism 92 serving as an up-down driving mechanism, a third mechanism 93 serving as an front-back driving mechanism, and a fourth mechanism 94 serving as a pressing mechanism as described below. It should be noted that the ear stimulating apparatus 100, 100a, or 100b may include at least one mechanism among these mechanisms 91 to 94.

Firstly, FIGS. 4A and 4B are views for illustrating the first mechanism 91 to be utilized at the time of belt drive where the contacts 102 are rotated in the arrow A direction in synchronization. FIG. 4A is a schematic view thereof and FIG. 4B is a partial top view thereof.

As shown in FIGS. 4A and 4B, the first mechanism 91 includes crown gears 105, the first pulleys 109, and the belts 104. Each crown gear 105 is meshed with a drive gear 106a of a rotation shaft of the actuator 106 arranged along the up and down direction so as to be forward/reversely rotated. The first pulleys 109 are connected in the axial direction of the contacts 102, so as to transfer a force in the forward/reverse rotation direction about center axes of the contacts 102 in parallel in the left and right direction to the contacts 102. The crown gear 105 and the first pulleys 109 are coupled by the belts 104. Therefore, the crown gear 105 is forward/reversely rotated by the force from the actuator 106, and the belts 104 are forward/backward driven via second pulleys 105a arranged coaxially with the crown gear 105. When the first pulleys 109 are forward/reversely rotated at once in synchronization by forward/backward driving of the belts 104, the contacts 102 are forward/reversely rotated in the arrow A direction (forward/reverse direction about the center axes of the contacts 102). At this time, when the contacts 102b are rotated and the contacts 102a are rotated in the same phase in the first unit 161 and the second unit 162, the front and back contacts 102b and 102a can nip the auricle 110 from the front side 110F and the back side 110R of the auricle 110, so as to perform circular movement like twisting. Conversely, when the contacts 102b are rotated and the contacts 102a are rotated in phases opposite to each other, the front and back contacts 102b and 102a can nip the auricle 110 from the front side 110F and the back side 110R of the auricle 110, so as to perform circular movement like twisting in the opposite directions between the front and back sides. The crown gear 105 is one example of a transfer mechanism for converting a rotation force of the rotation shaft into a force in the direction orthogonal to the rotation shaft. A transfer mechanism of a positive phase or an opposite phase can be arbitrarily formed by appropriately adding a gear or the like.

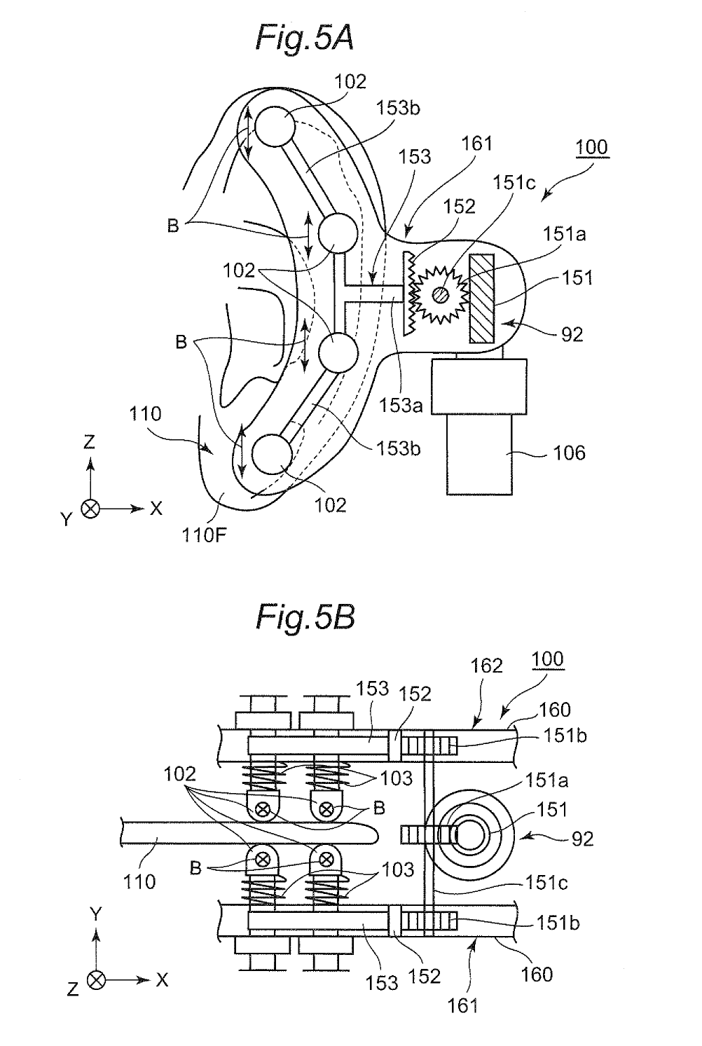

Next, FIGS. 5A and 5B are views for illustrating the second mechanism 92 to be utilized at the time of upper and lower link drive where the contacts 102 are moved upward and downward in the arrow B direction. FIG. 5A is a schematic view thereof and FIG. 5B is a partial top view thereof. It should be noted that although a worm gear 151, racks 152, links 153, and the like are arranged inside the case 160, those parts are shown by solid lines in FIGS. 5A and 5B for easy understanding.

As shown in FIGS. 5A and 5B, the second mechanism 92 includes the worm gear 151, a pinion gear 151a, a pair of pinion gears 151b on both sides, the racks 152, and the links 153. The worm gear 151 is coupled to the rotation shaft of the actuator 106 arranged along the up and down direction so as to be forward/reversely rotated. The pinion gear 151a is meshed with the worm gear 151. The pinion gears 151b on both the sides are fixed to both ends of a rotation shaft 151c arranged in the left and right direction and the pinion gear 151a is fixed to a center part of the rotation shaft, so that the pinion gears 151a, 151b are forward/reversely rotated in synchronization. The racks 152 are arranged along the up and down direction and respectively meshed with the pinion gears 151b. The links 153 arranged in the up and down direction are coupled to the racks 152, so as to transfer the force in the perpendicular direction (up and down direction), to the contacts 102. In detail, each of the links 153 is composed of a substantially Y-shaped member coupled to the four contacts arranged at the four vertices of the isosceles trapezoid (see the trapezoid IT indicated by alternate long and short dashed lines in FIG. 1A). A center end 153a of the substantially Y-shaped member serving as the link 153 is fixed to a center part on a plane of a back surface of the rack 152, and the contacts 102 are coupled to fork portions 153b. Therefore, the force in the forward/reverse rotation direction of the actuator 106 is converted into the force in the perpendicular direction (up and down direction) by the worm gear 151, the pinion gears 151a and 151b, and the racks 152, and transferred to the links 153. The links 153 transfer the force in the perpendicular direction (up and down direction), to the contacts 102. As a result, the contacts 102 are moved in the up and down direction (arrow B direction), so that friction is generated in the auricle 110 and rubbing massage like pulling the auricle 110 upward and downward can be realized.

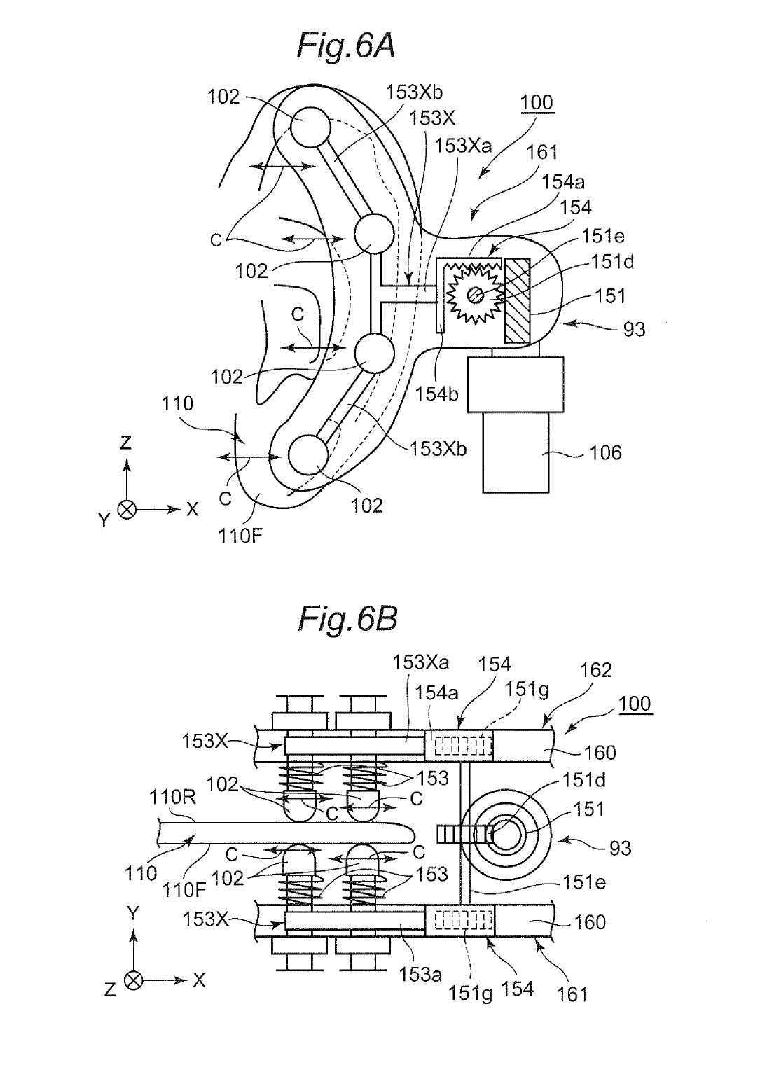

Next, FIGS. 6A and 6B are views for illustrating the third mechanism 93 to be utilized at the time of front and back link drive where the contacts 102 are moved forward and backward in the arrow C direction. FIG. 6A is a schematic view thereof and FIG. 6B is a partial top view thereof. It should be noted that although a worm gear 151, racks 154, links 153X, and the like are arranged inside the case 160, those parts are shown by solid lines in FIGS. 6A and 6B for easy understanding.

As shown in FIGS. 6A and 6B, the third mechanism 93 includes the worm gear 151, a pinion gear 151d, a pair of pinion gears 151g on both sides, the racks 154, and the links 153X. The worm gear 151 is coupled to the rotation shaft of the actuator 106 arranged along the up and down direction so as to be forward/reversely rotated. The pinion gear 151d is meshed with the worm gear 151. The pinion gears 151g on both the sides are fixed to both ends of a rotation shaft 151e arranged in the left and right direction, the rotation shaft in which the pinion gear 151d is fixed to a center part thereof, so that the pinion gears 151g, 151d are forward/reversely rotated in synchronization with the rotation shaft 151e. The racks 154 are respectively meshed with the pinion gears 151g. The links 153X arranged in the up and down direction are coupled to the racks 154, so as to transfer the force along the front and back direction to the contacts 102. In more detail, each of the racks 154 has a first plate portion 154a along the front and back direction, and a second plate portion 154b along the up and down direction coupled to the first plate portion 154a. The first plate portion 154a has a tooth portion to be meshed with each of the pinion gears 151g on a lower surface thereof. Each of the links 153X is composed of a substantially Y-shaped member coupled to the four contacts 102 arranged at the four vertices of the isosceles trapezoid (see the trapezoid IT indicated by alternate long and short dashed lines in FIG. 1A). A center end 153Xa of the link 153X is fixed to a center part on a plane of a back surface of the second plate portion 154b of the rack 152, and the contacts 102 are coupled to fork portions 153Xb. The force in the forward/reverse rotation direction of the actuator 106 is converted into the force in the perpendicular direction (front and back direction) by the worm gear 151, the pinion gears 151d and 151g, and the racks 154, and transferred to the links 153X. Therefore, in the third mechanism 93, by moving the contacts 102 in the front and back direction (arrow C direction) with respect to the case 160, a friction operation to the auricle 110 or a rubbing massage operation like pulling the auricle 110 outward or inward can be realized.

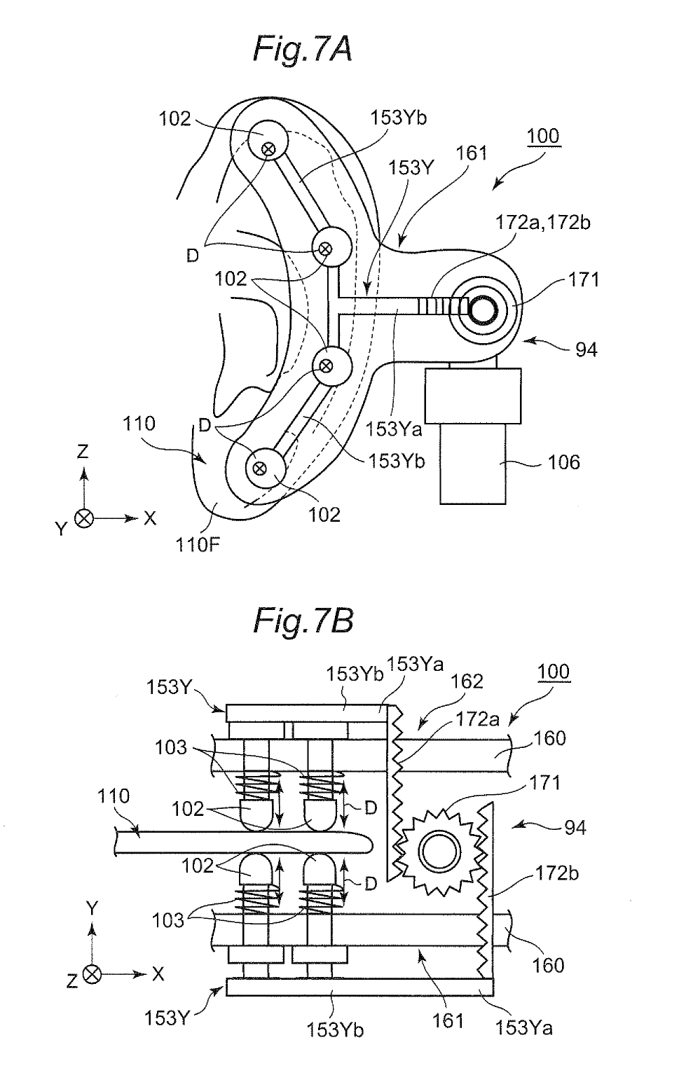

FIGS. 7A and 7B are views for illustrating the fourth mechanism 94 to be utilized at the time of pressing drive where the contacts 102 are moved in the arrow D direction. FIG. 7A is a schematic view thereof and FIG. 7B is a partial top view thereof. It should be noted that although a pinion gear 171, racks 172a and 172b, links 153Y, and the like are not exposed to the surface, those parts are shown by solid lines in FIGS. 7A and 7B for easy understanding.

As shown in FIGS. 7A and 7B, the fourth mechanism 94 includes the pinion gear 171, the pair of racks 172a and 172b, and the links 153Y. The pinion gear 171 is coupled to the rotation shaft of the actuator 106 arranged along the up and down direction so as to be forward/reversely rotated. The racks 172a and 172b are arranged in the lateral direction and meshed with the pinion gear 171. The links 153Y are arranged in the up and down direction and coupled to the racks 172a and 172b, so as to transfer the force in the horizontal direction (left and right direction) to the contacts 102. When seen from the upper side, the racks 172a and 172b are arranged so as to be meshed with the pinion gear 171 from the left and right sides. That is, the racks 172a, 172b are arranged in such a manner that a leading end of the rack 172a on the side of the second unit 162 is meshed with a front side of the pinion gear 171 and a leading end of the rack 172b on the side of the first unit 161 is meshed with a back side of the pinion gear 171. Each of the links 153Y is composed of a substantially Y-shaped member coupled to the four contacts 102 arranged at the four vertices of the isosceles trapezoid (see the trapezoid IT indicated by alternate long and short dashed lines in FIG. 1A). A center end 153Ya of the link 153Y is fixed so as to be orthogonal to the rack 172a or 172b. That is, a rear end of the rack 172a is fixed so as to be orthogonal to the center end 153Ya of the link 153Y on the side of the second unit 162, and a rear end of the rack 172b is fixed so as to be orthogonal to the center end 153Ya of the link 153Y on the side of the first unit 161. The contacts 102 are coupled to branch portions 153Yb of the link 153Y. The force in the forward/reverse rotation direction of the actuator 106 is converted into the force in the horizontal direction (left and right direction) by the pinion gear 171 and the racks 172a and 172b, and transferred to the links 153Y. Therefore, in the fourth mechanism 94, by moving the contacts 102 in the pressing direction (arrow D direction) with respect to the case 160, the auricle 110 can be pressed. It should be noted that in the fourth mechanism 94, by respectively interlocking the plurality of contacts 102 on the front and back sides of the auricle 110 with each other, an operation of temporarily elastically deforming the auricle 110 can be realized.

Successively, an operation of stimulating the auricle 110 will be described. The operation of stimulating the auricle 110 is an operation of combining and performing the operations in the arrow A to D directions described with reference to FIGS. 4A to 7B. In this case, the above mechanisms 91 to 94 required for the operations are appropriately assembled into the ear stimulating apparatus 100, so that the contacts 102 are moved in a desired manner. It should be noted that in the following description, the contacts 102 arranged on the rear head side of the auricle 110 (back side 110R of the auricle 110) are the contacts 102a, and the contacts 102 arranged on the outer side of the auricle 110 (front side 110F of the auricle 110) are the contacts 102b.

It should be noted that since a frictional coefficient of each of the contacts 102a is larger than a frictional coefficient of each of the contacts 102b, the auricle 110 can be stimulated by the contacts 102b on the front side 110F of the auricle 110 in a state where the auricle 110 is lightly held by the contacts 102a on the back side 110R of the auricle 110.

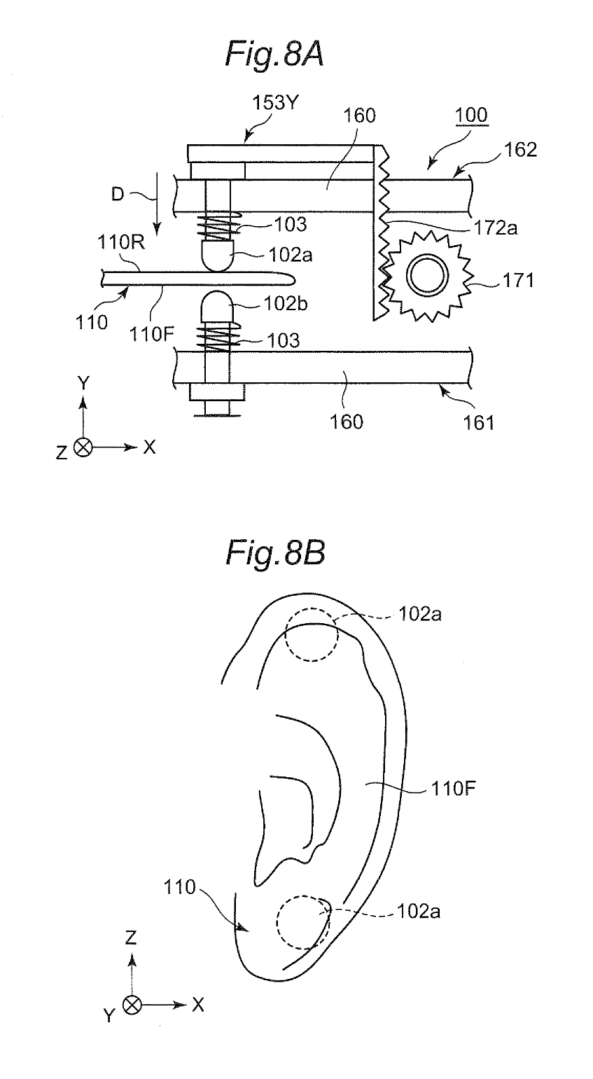

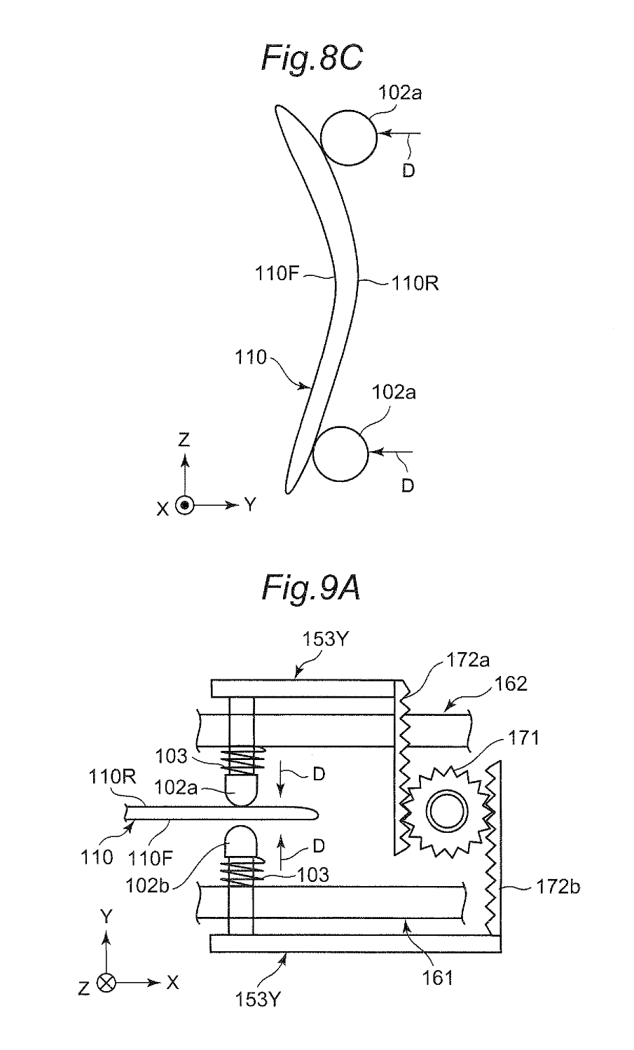

FIGS. 5A to 5C are views for illustrating an operation of interlocking the contacts 102 with each other and slightly bending the auricle 110. The operation of slightly bending the auricle 110 is an operation of continuously switching a state where the auricle 110 is slightly bent and a normal state. FIG. 5A is a partial top view thereof, FIG. 8B is a view in which the auricle 110 is seen from the front side 110F, and FIG. 5C is a view in which the auricle 110 is seen from the rear head side (back side 110R).

As shown in FIGS. 8A to 8C, by interlocking the two upper and lower contacts 102a arranged on the rear head side (back side 110R) and letting the contacts 102a perform a forward pressing operation, the auricle 110 can be slightly bent. It is thought that by temporarily slightly deforming the auricle 110 in a V shape as shown in FIGS. 5A to 5C, the acupressure points of the auricle 110 can be locally stimulated. Altogether, it is thought that by temporarily inhibiting the blood flow by the slight bending due to the temporary deformation of the auricle 110 and then cancelling the temporary deformation, a state of the blood flow of the auricle 110 can be improved.

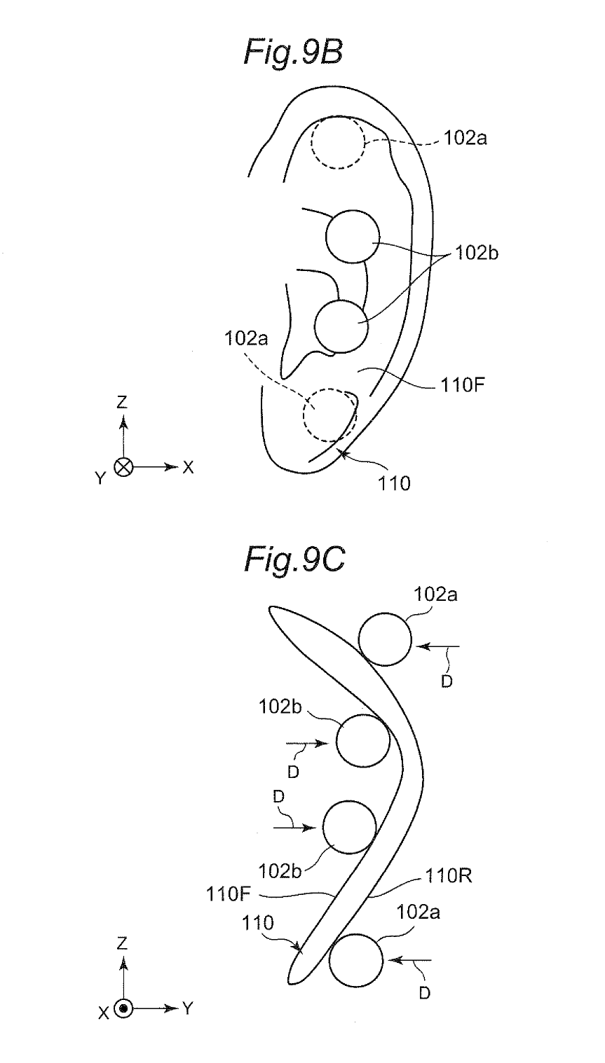

FIGS. 9A to 9C are views for illustrating an operation of largely bending the auricle 110. FIG. 9A is a partial top view thereof, FIG. 9B is a view in which the auricle 110 is seen from the front side 110F, and FIG. 9C is a view in which the auricle 110 is seen from the rear head side (back side 110R).

As shown in FIGS. 9A to 9C, by interlocking and operating the two upper and lower contacts 102a and the two center contacts 102b, the auricle 110 can be largely bent. At this time, since the two center contacts 102b serve as support points, the auricle 110 is largely bent. It should be noted that at least one contact 102b is required to be arranged as the contact 102b serving as the support point. It is thought that by temporarily largely deforming the auricle 110 in a V shape as shown in FIGS. 9A to 9C, the acupressure points of the auricle 110 can be locally strongly stimulated by the temporary deformation of the auricle 110. Further, it is thought that by temporarily inhibiting the blood flow by the large bending due to the temporary deformation of the auricle 110 and then cancelling the temporary deformation, the state of the blood flow of the auricle 110 can be largely improved.

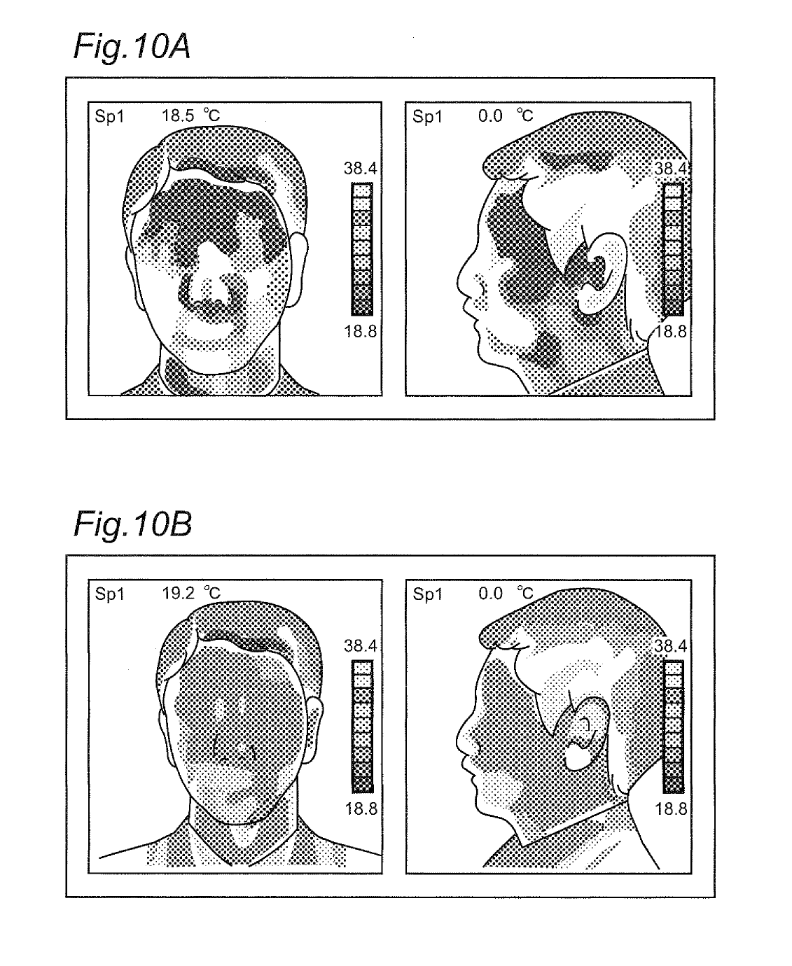

In order to illustrate an effect of the ear stimulating apparatus 100 of the first embodiment, FIGS. 10A and 10B show face temperatures before and after using the ear stimulating apparatus 100. FIG. 10A is a view showing the face temperature before using the ear stimulating apparatus 100, and FIG. 10B is a view showing the face temperature after using the ear stimulating apparatus 100. As clear from FIGS. 10A and 10B, it is found that by stimulating the auricle 110 with using the ear stimulating apparatus 100 of the first embodiment, the face temperature is increased (gray regions are expanded). For example, although the gray region is up to an upper half in a front view of the face on the left side of the FIG. 10A, the gray region is all over the face in a front view of the face on the left side of FIG. 10B. In addition, although the gray region is up to an upper half in a side view of the face on the right side of the FIG. 10A, the gray region is all over the face in a side view of the face on the right side of FIG. 10B. From this result, it is also found that the ear stimulating apparatus 100 of the first embodiment facilitates the blood flow of the face and increases the face temperature.

It should be noted that the switch 108 may be not a type to be installed in the case 160 but a remote controller type. When the switch 108 is the remove controller type, the switch 108 can be manipulated while visually confirming the switch 108.

It should be noted that in the fastener 101, a length on the front side 110F of the auricle 110 may be differentiated from a length on the back side 110R of the auricle 110. By differentiating the length from each other, stability of the ear stimulating apparatus 100 can be enhanced with respect to moment generated by contact between the contacts 102 and the auricle 110.

It should be noted that the fastener 101 may be not a clip shape but a shape to be hanged onto the back side 110R of the auricle 110 or a shape to domically cover the auricle 110 like a headphone.

It should be noted that in any case where the contacts 102 are moved in the up and down direction, the left and right direction, the front and back direction, and the circular direction, the contacts 102b arranged on the front side 110F of the auricle 110 and the contacts 102a arranged on the back side 110R of the auricle 110 may be operated in the phases opposite to each other. By operating the contacts 102 on the front and back sides in the phases opposite to each other, the auricle 110 can be more strongly stimulated.

By making the frictional coefficient of each of the contacts 102a arranged on the back side 110R of the auricle 110 larger than the frictional coefficient of each of the contacts 102b arranged on the front side 110F of the auricle 110, stimulation such as friction can be enhanced on the front side 110F of the auricle 110 where the effect of the ear stimulation is thought to be high. In such a way, by changing the frictional coefficient of the contacts 102 between the front and back sides, the blood flow of the auricle 110 is further effectively facilitated.

It is thought that by partially changing the frictional coefficient on the surface of one of the contacts 102, a friction difference can be provided at the time of stimulating the auricle 110 and effective ear stimulation can be performed. For example, by making a friction coefficient on the lower side of the surface of the contact 102 larger than a frictional coefficient on the upper side, large friction can be generated when the contact 102 is moved to the lower side.

(First Example of Operation of Ear Stimulating Apparatus)

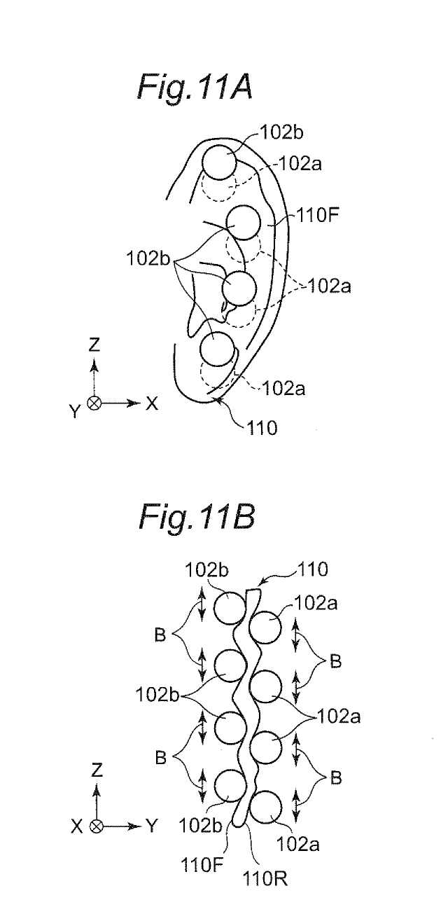

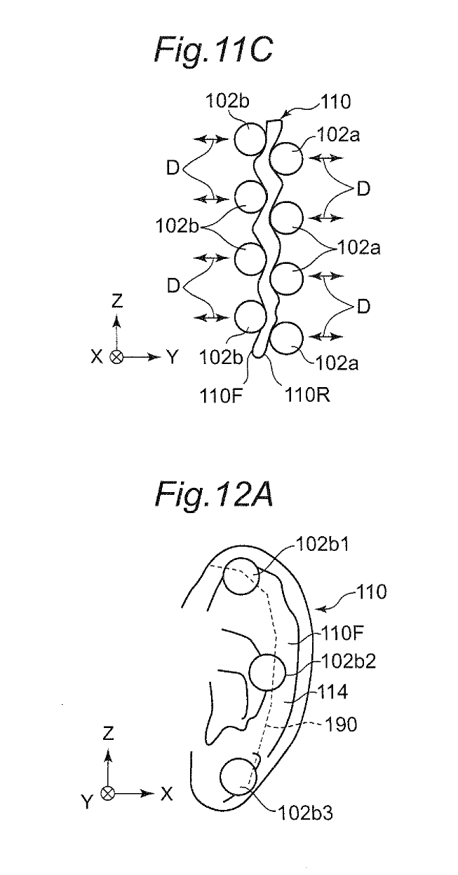

With reference to FIGS. 11A to 11C, a first example of the operation of the ear stimulating apparatus 100 will be described. As shown in FIG. 11A, in this first example of the operation, the plurality of contacts 102b on the front side 110F of the auricle 110 and the plurality of contacts 102a on the back side 110R of the auricle 110 are arranged at positions displaced from each other. In such a way, by arranging the pluralities of contacts 102a and 102b on the back and front sides of the auricle 110 at the displaced positions, the auricle 110 can be nipped while being temporarily deformed as shown in FIGS. 11B and 11C. The displaced positions are positions of at least three vertices of a triangle of the second unit 162, at least one vertex among the three vertices being placed between two vertices among vertices of a triangle of the first unit 161 or in the vicinity of a part between the two vertices.

In this first example of the operation, after the auricle 110 is nipped from the back and front sides by the pluralities of contacts 102a and 102b arranged at the positions displaced from each other, all the contacts 102a and 102b are synchronized, and up and down movement shown in FIG. 11B or left and right movement shown in FIG. 11C are performed. The up and down movement shown in FIG. 11B is an operation of moving the contacts 102a and 102b in the up and down direction (arrow B direction) while the auricle 110 is nipped by the contacts 102a and 102b. The left and right movement shown in FIG. 11C is an operation of alternately moving the contacts 102a and 102b in the direction coming close to the auricle 110 and in the direction going away from the auricle 110 (arrow D direction) to press the auricle 110.

(Second Example of Operation of Ear Stimulating Apparatus)

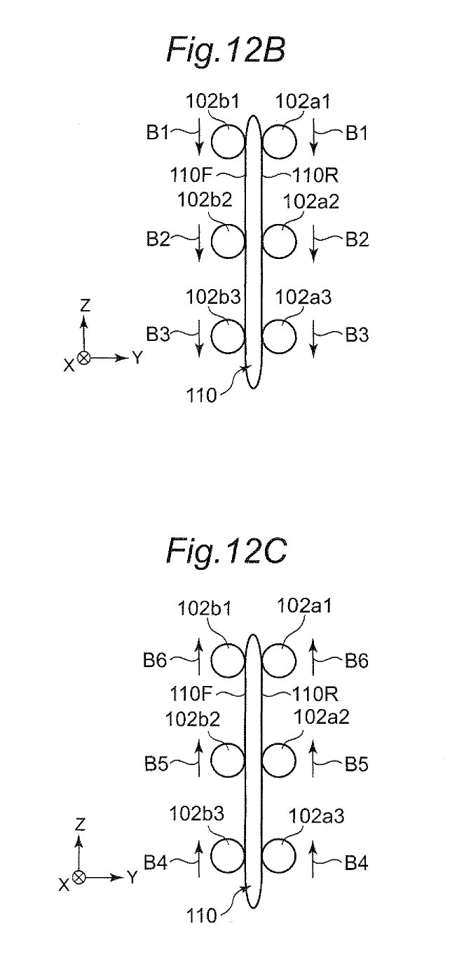

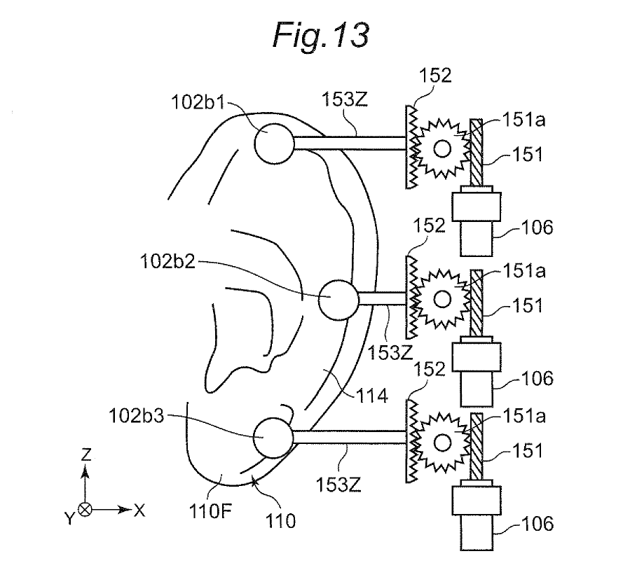

With reference to FIGS. 12A to 12C and 13, a second example of the operation of the ear stimulating apparatus 100 will be described. The operation shown in FIGS. 12A to 12C is to stimulate the auricle 110 by moving the plurality of contacts 102 in turns from the upper side to the lower side and then from the lower side to the upper side along the antihelix 114 of the auricle 110.

This second example of the operation can be realized as shown in FIG. 13, for example, by respectively independently providing the second mechanism 92 shown in FIGS. 5A and 5B for each of the plurality of contacts 102. It should be noted that links 153Z correspond to the links 153 of FIG. 5A and the like.

With FIGS. 12A to 12C and 13, for simple description, a description will be given of a case where three contacts 102b1, 102b2, and 102b3 are arranged on the front side 110F of the auricle 110, and three contacts 102a1, 102a2 and 102a3 are arranged on the back side 110R of the auricle 110. It should be noted that in this second example of the operation, at least two or more contacts 102 are required to exist on the front or back side.

As shown in FIG. 12A, in this second example of the operation, the contacts 102b (102b1; 102b2, and 102b3) on the front side 110F of the auricle 110 and the contacts 102a (102a1, 102a2, and 102a3) on the back side 110R of the auricle 110 are arranged at positions facing each other (where the contacts face each other on the front and back sides). In this second example of the operation, by stimulating the auricle 110 with the contacts 102a and 102b on the back and front sides arranged at the facing positions, stimulation like stroking the auricle 110 upward and downward can be added. It is thought that by such stimulation like stroking the auricle 110, the antihelix 114 to be said to correspond to the backbone of the human body can be stimulated in turns, and smooth passage of vital energy and blood through the backbone can be facilitated.

In this second example of the operation, in the contacts 102, the contacts 102a1 and 102b1 are firstly moved in the arrow B1 direction from the upper side of the auricle 110 to the lower side at the same time as shown in FIG. 12B. Successively, the contacts 102a2 and 102b2 are moved in the arrow B2 direction from the upper side of the auricle 110 to the lower side at the same time. Further successively, the contacts 102a3 and 102b3 are moved in the arrow B3 direction from the upper side of the auricle 110 to the lower side at the same time. By such an operation, the contacts 102 are moved in turns from the upper part of the auricle 110 toward the lower side of the auricle 110. An operation amount of each of the contacts 102 at this time is, for example, about 10 mm although depending on a size of the auricle 110. Then, after the contacts 102a3 and 102b3 are moved to the lower part of the auricle 110, the contacts 102a3 and 102b3 are moved in the arrow B4 direction from the lower side of the auricle 110 to the upper side at the same time as shown in FIG. 12C. Successively, the contacts 102a2 and 102b2 are moved in the arrow B5 direction from the lower side of the auricle 110 to the upper side at the same time. Further successively, the contacts 102a1 and 102b1 are moved in the arrow B6 direction from the lower side of the auricle 110 to the upper side. By such an operation, the contacts 102 are moved in turns from the lower part of the auricle 110 toward the upper side of the auricle 110. By repeating the series of operations of FIGS. 12B and 12C, the stimulation like stroking the auricle 110 upward and downward can be added.

(Third Example of Operation of Ear Stimulating Apparatus)

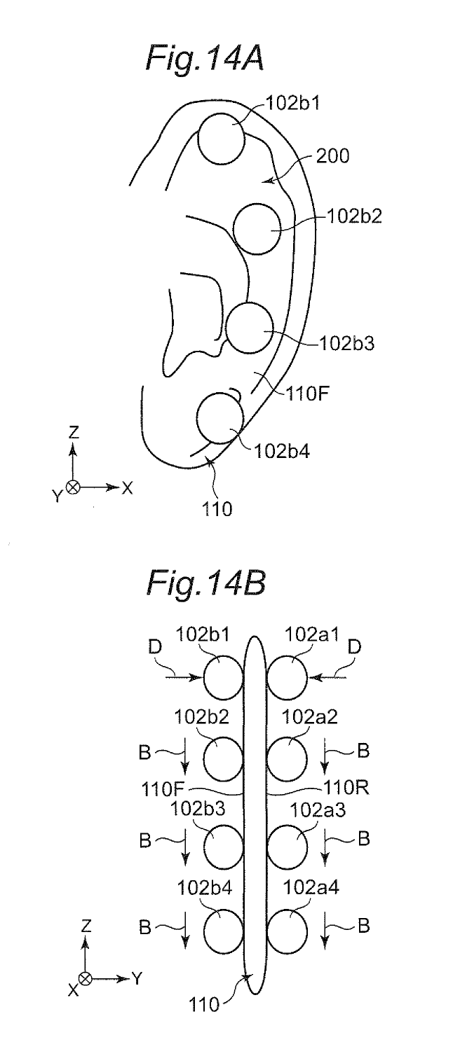

With reference to FIGS. 14A and 14B, a third example of the operation of the ear stimulating apparatus 100 will be described. Firstly, the contacts 102a1 to 102a4 are arranged in such a manner that the contact 102a1 of an upper end is come into contact with a depressing groove 200 on the back side 110R of the auricle 110, and the contacts 102b1 to 102b4 are also arranged on the front side 110F of the auricle 110 in correspondence with these contacts 102a1 to 102a4 as shown in FIG. 14A. Then, in a state where the uppermost contacts 102a1 and 102b1 are moved in the arrow B direction to nip and hold the auricle 110, the auricle 110 is pulled downward (in the arrow B direction) by the remaining contacts 102a2 to 102a4 and 102b2 to 102b4 as shown in FIG. 14B. This third example of the operation can be realized with at least two pairs of contacts (four contacts) 102. By such an operation, the depressing groove 200 can be directly stimulated, so that, for example, blood pressure can be lowered.

It should be noted that the uppermost contacts 102a1 and 102b1 are moved in the arrow D direction to nip and hold the auricle 110. However, in a case where the stimulation to the auricle 110 can be changed, the lowermost contacts 102a4 and 102b4 may be moved in the arrow D direction to nip and hold the auricle 110, and the remaining contacts 102a1 to 102a3 and 102b1 to 102b3 may be moved upward to pull the auricle 110.

(Fourth Example of Operation of Ear Stimulating Apparatus)

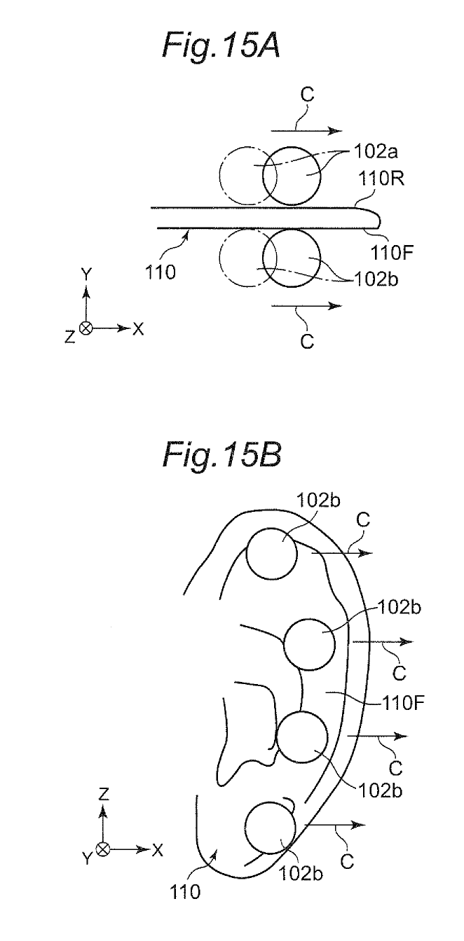

With reference to FIGS. 15A and 15B, a fourth example of the operation of the ear stimulating apparatus 100 will be described. The operation of the fourth example is to move the contacts 102 like pulling the entire auricle 110 in the sideways direction (arrow C direction) as shown in FIGS. 15A and 15B. At this time, by making a time of moving the contacts 102 toward the outer side of the auricle 110 and stopping at an outermost part longer than a time of moving the contacts toward the inner side of the auricle 110, the auricle 110 can be pulled sideways. Alternatively, at this time, by making a force of moving the contacts 102 toward the outer side of the auricle 110 stronger than a force of moving the contacts toward the inner side of the auricle 110, the auricle 110 can be pulled sideways.

By moving the auricle 110 in the sideways direction in such a way, an aperture called the jugular for amen between the temporal bone and the occipital bone, through which important nerves and blood vessels such as the internal jugular vein, the vagal nerve, the accessory nerve or the glossopharyngeal nerve pass can be opened and loosened, so that blood circulation promotion can be realized. The temporal bone attached to the ear or the cranial dura mater inside the temporal bone can be pulled, so that overstressing or unbalance of the dura mater relating to the skull can be adjusted.

(Fifth Example of Operation of Ear Stimulating Apparatus)

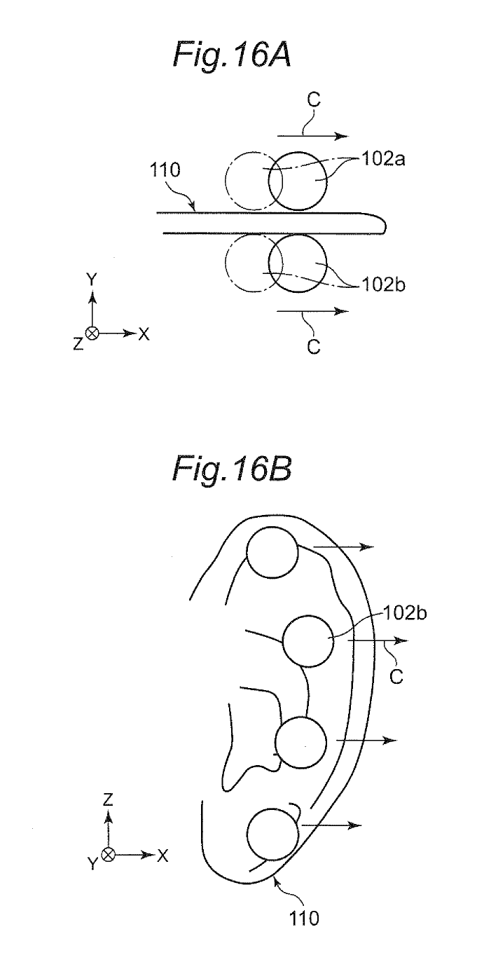

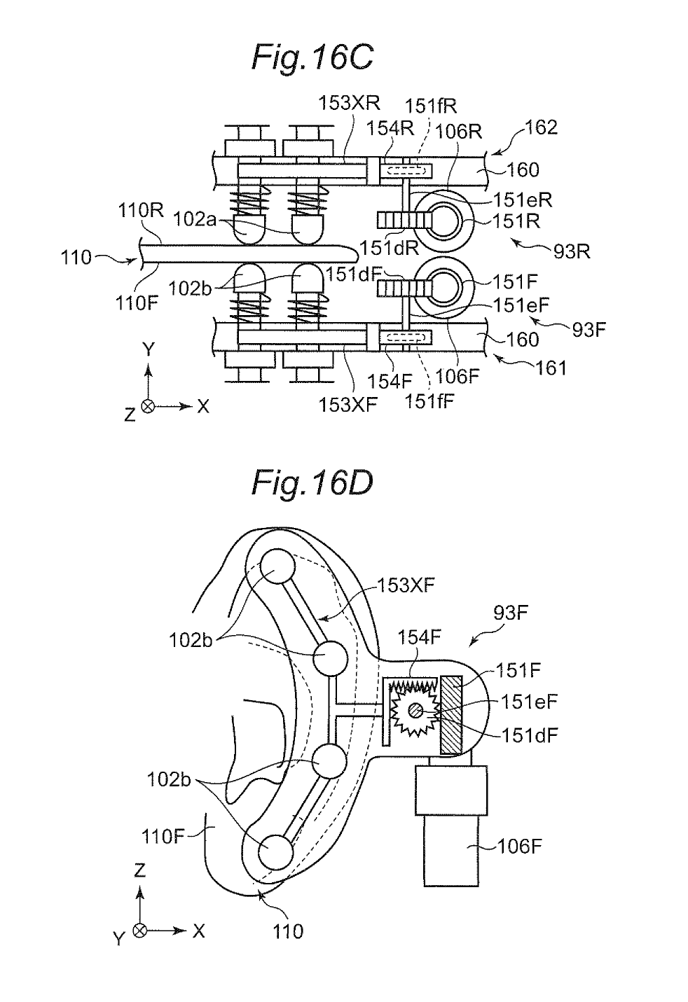

With reference to FIGS. 16A to 16D, a fifth example of the operation of the ear stimulating apparatus 100 will be described. The operation of the fifth example is to move the contacts 102 like repeating a stroke of the front side 110F of the auricle 110 toward the outer side and then a stroke of the back side 110R of the auricle 110 toward the outer side. Thereby, the entire auricle 110 can be stimulated, so that recovery from fatigue, prevention of dementia, hearing impairment, or tinnitus can be improved.

As shown in FIGS. 16C and 16D, this operation of the fifth example can be achieved by respectively independently providing the third mechanism 93 shown in FIGS. 6A and 6B for each of the first unit 161 and the second unit 162, and operating the third mechanism independently for each of the units. Specifically, in the fifth example, third mechanisms 93F and 93R are provided in the first unit 161 and the second unit 162. The third mechanisms 93F and 93R have worm gears 151F and 151R, pinion gears 151dF and 151dR, a pair of pinion gears 151fF and 151fR on both sides, racks 154F and 154R, and links 153XF and 153XR. Via the third mechanisms 93F and 93R, forward rotation drive of actuators 106F and 106R is transferred to the contacts 102a and 102b and the contacts 102a and 102b are driven toward the outer side of the auricle 110, and reverse rotation drive of the actuators 106F and 106R is transferred to the contacts 102a and 102b and the contacts 102a and 102b are driven toward the outer side of the auricle 110. By repeating this, the contacts 102b on the front side 110F of the auricle 110 are driven from the inner side of the auricle 110 to the outer side, and the contacts 102a on the back side 110R of the auricle 110 are driven from the inner side of the auricle 110 to the outer side, continuously. Thus, the operation like stroking the front side 110E and the back side 110R of the auricle 110 with the contacts 102 can be performed.

### Modified Example of First Embodiment

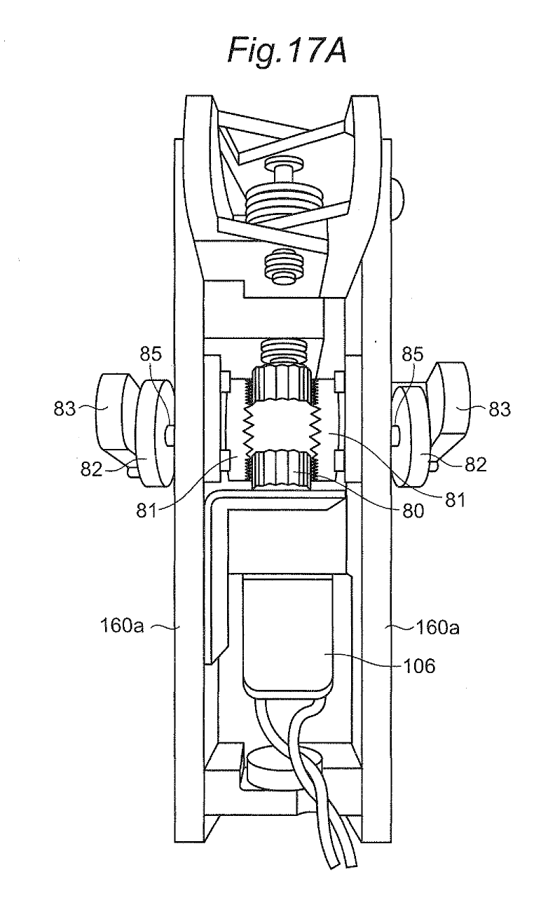

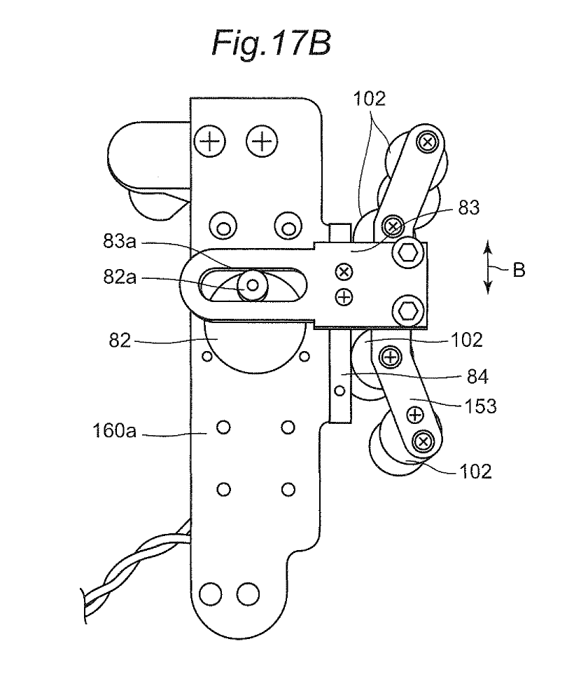

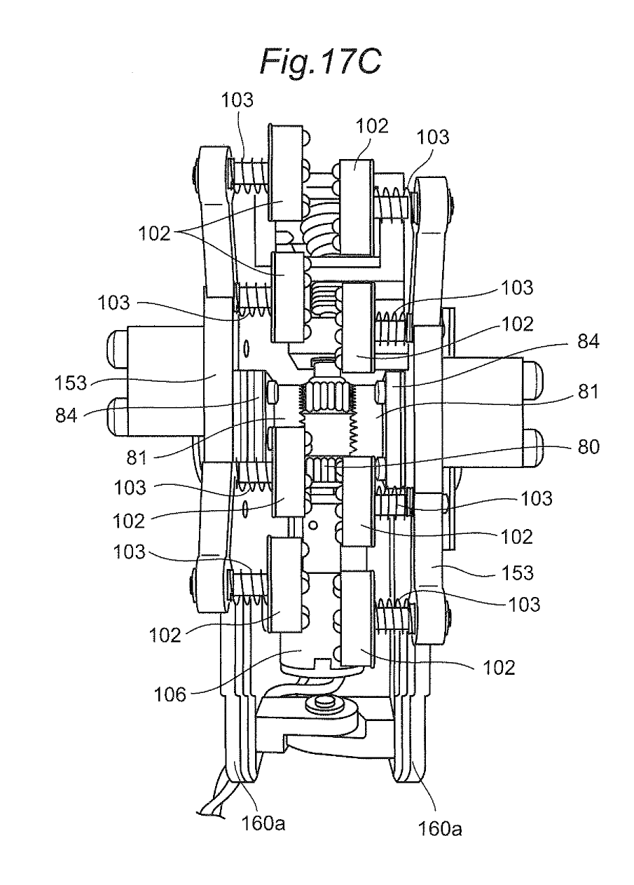

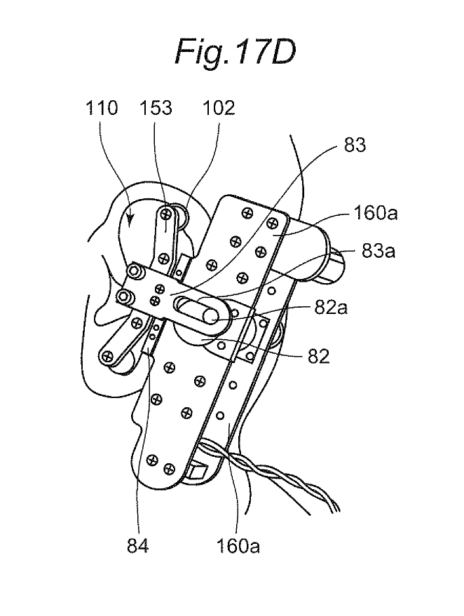

FIG. 17A is a front view of an ear stimulating apparatus 100 in a modified example of the first embodiment, and FIGS. 17B to 17D are respectively a right side view and a back view of the ear stimulating apparatus 100 of FIG. 17A, and an illustrative view of a state where the ear stimulating apparatus 100 of FIG. 17A is worn on the ear.

The ear stimulating apparatus 100 includes an actuator 106 such as an electric motor, a drive gear 80, crown gears 81, rotation plates 82 having engagement projections 82a, cam members 83 having long grooves 83a, slide guiding members 84, and links 153 between a pair of plate cases 160a. The crown gears 81 are meshed with the drive gear 80 of a rotation shaft of the actuator 106 arranged along the up and down direction, so as to be forward/reversely rotated. The drive gear 80 is coupled by a rotation shaft 85 along the left and right direction and forward/reversely rotates the rotation plates 82 on outer surfaces of the plate cases 160a. The rotation plates 82 have the engagement projections 82a at positions eccentric from a center axis, and are engaged with the long grooves 83a of the cam members 83. The slide guiding members 84 are fixed to edges along the up and down direction of the cases 160a. The cam members 83 are attached to the slide guiding members 84 slidably along the up and down direction. When the rotation plates 82 are rotated, the cam members 83 are moved along the up and down direction with respect to the slide guiding members 84 via engagement between the engagement projections 82a and the long grooves 83a. Center ends 153a of the links 153 serving as substantially Y-shaped members are fixed to the cam members 83. The force in the forward/reverse rotation direction of the actuator 106 is converted into the force in the perpendicular direction (up and down direction) by the crown gears 81, the rotation plates 82, the cam members 83, and the slide guiding members 84, and transferred to the links 153. That is, the links 153 transfer the force in the perpendicular direction (up and down direction) to the contacts 102. As a result, by moving the contacts 102 in the up and down direction (arrow B direction) with respect to the cases 160a, friction is generated in the auricle 110, so that rubbing massage like pulling the auricle 110 upward and downward can be realized.

### Second Embodiment

Next, an ear stimulating apparatus 100M according to a second embodiment of the present invention, the ear stimulating apparatus being capable of reducing an influence of driving noise generated in a first transfer member 90 will be described.

Firstly, before describing this ear stimulating apparatus 100M according to the second embodiment, the conventional technique will be simply described. For example, with a conventional ear stimulating apparatus, there is sometimes a case where stimulation to an ear is insufficient. As a method of strengthening the stimulation to the ear, for example, a device in which drive is strengthened by an actuator is considered. In this case, it is thought that by applying the technique of Patent Literature 2 described above, the influence of the driving noise can be reduced. However, the massage chair is for a waist part and a shoulder part, and sources of the driving noise are generally away from the ear. Therefore, in the ear stimulating apparatus, unlike a case of the massage chair or the like, a countermeasure against the driving noise is highly possibly required.

The second embodiment according to the present invention is to solve this problem, and an object thereof is to reduce the influence of the driving noise in the ear stimulating apparatus.

Hereinafter, the second embodiment of the present invention will be described with reference to the drawings. It should be noted that the same constituent elements will be given the same reference signs, and description thereof will sometimes be omitted. For easy understanding, the drawings are schematic focusing on the respective constituent elements.

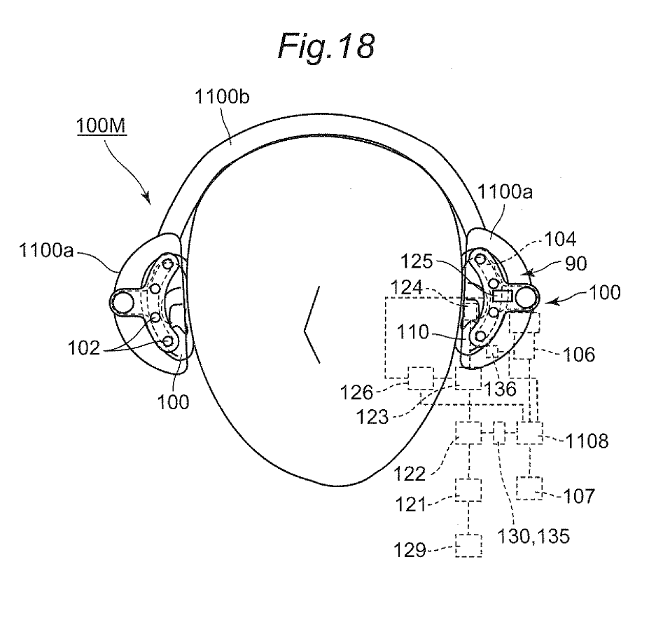

FIG. 18 is an entire configuration view of the ear stimulating apparatus 100M in the second embodiment of the present invention. The ear stimulating apparatus 100M shown in FIG. 18 is a headphone type device to be worn on the auricles 110. The ear stimulating apparatus 100M includes two housings 1100a that cover left and right ears, and a headband 1100b that connects the housings 1100a. Since the ear stimulating apparatus 100M in the second embodiment is a headphone type device as described above, weight of constituent elements such as contacts 102 can be held not only by the auricle 110 but also by a head part of a user. Therefore, a wearer (user) of the ear stimulating apparatus 100M can receive ear stimulation in various postures such as a seated position or a lateral position. In each of the housings 1100a, the ear stimulating apparatus 100, 100a, or 100b of the first embodiment is arranged. It should be noted that only the reference sign 100 is shown as a representative in the drawings.

It should be noted that in FIG. 18, the contacts 102 arranged in the housing 1100a are shown by solid lines for easy understanding. In FIG. 18, the constituent elements such as an actuator 106 arranged in the housing 1100a or the headband 1100b are shown by broken lines outside the housing 1100a or the headband 1100b for easy understanding of respective connection relationships.

The ear stimulating apparatus 100M of the second embodiment includes four contacts 102 on each of the front and back sides, the actuator 106, the first transfer member 90, and a power supply 107 in each of the housings 1100a as well as the ear stimulating apparatuses 100, 100a, and 100b and the like of the first embodiment. Further, the ear stimulating apparatus 100M includes a second control unit 1108 serving as an actuator control unit, a second detection unit 125 serving as a driving noise detection unit, a first memory unit 129 serving as a music data memory unit, a playing unit 121 serving as a music playing unit, a first detection unit 122 serving as a music detection unit, a first calculation unit 126 serving as a delay time calculation unit, a first generation unit 123 serving as a delay generation unit, and speaker units 124. The actuator 106 is composed of an electric motor or the like. The first transfer member 90 transfers a force from the actuator 106 to the contacts 102. The power supply 107 operates the actuator 106.

The second control unit 1108 controls an input signal (such as voltage or electric current) to the actuator 106 based on a volume level of music to be played (amplitude of music data), so as to control torque or/and rotation speed of the actuator 106.

The second detection unit 125 measures the driving noise generated in the first transfer member 90. The second detection unit 125 is installed in the vicinity of the first transfer member 90 composed of gears and the like serving as a major cause of the driving noise in the direction in which a detecting section thereof faces the first transfer member 90. By installing the second detection unit 125 in such a direction, the driving noise can be reliably detected.

The first memory unit 129 stores the music data to be played.

The playing unit 121 reads the music data to be played from the first memory unit 129 and plays predetermined music.

The first detection unit 122 detects the volume level of the music played by the playing unit 121. Specifically, the first detection unit 122 is composed of a microphone or the like, and detects the volume level of the music based on the amplitude of the music data read by the playing unit 121. Instead of the volume level, other musical characteristics such as a tempo may be detected.

The first calculation unit 126 calculates a delay time “Tds” (=Td1+Td2) in the first transfer member 90 or the like when drive of the actuator 106 is transferred to the contacts 102. The delay time “Tds” is considered in such a way due to the following reasons. Firstly, in a case where the first transfer member 90 is composed of a gear train of a plurality of gears or the like in order to transfer the drive of the actuator 106, a transfer delay to be described later is generated due to a play or the like in the gear train. Thus, there is a need for considering the delay time “Td1” relating to the first transfer member 90. Since a transfer delay based on the played music is also generated, there is a need for considering the delay time “Td2” relating to the played music. Therefore, there is a need for considering the delay time “Tds” serving as the sum of the delay time “Td1” and the delay time “Td2”.

The first generation unit 123 lets the playing unit 121 play the music delayed for the delay time “Tds” Td1+Td2) calculated in the first calculation unit 126.

The speaker unit 124 transfers the music delayed by the first generation unit 123 to the ear. The speaker unit 124 is arranged on the further inner side (side of each auricle 110) of arrangement positions of the contacts 102 in an earphone-like shape in such a manner that sound generated from the speaker unit 124 is dominantly delivered to the eardrum of each auricle 110.

The ear stimulating apparatus 100M of the second embodiment has at least two contacts 102b arranged on the front side 110F of each auricle 110. When at least two contacts 102 are provided in such a way, the ear stimulation can be performed. However, an example that four contacts 102 are brought into contact with each auricle 110 on each of the front side 110F and the back side 110R of each auricle 110 will be illustrated in the following description.

Although details will be described later, the ear stimulating apparatus 100M of the second embodiment is characterized by having a configuration for detecting the driving noise by the second detection unit 125 installed in the vicinity of the first transfer member 90 and playing the music delayed in consideration with the delay time in the first transfer member 90 by the playing unit 121. By having this characteristic, in the second embodiment, the comfortable ear stimulating apparatus 100M is realized in which the driving noise generated in the first transfer member 90 or the like of the ear stimulating apparatus 100M is cancelled by the music delayed for the delay time and the influence of the driving noise is small.

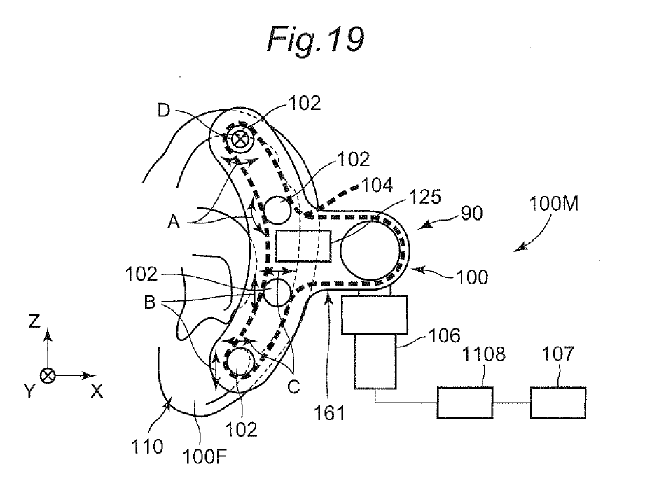

The mechanisms of the ear stimulating apparatus 100M of the second embodiment for stimulating the auricles 110 will be described with reference to FIGS. 19 and 21. The ear stimulating apparatus 100M in the second embodiment is an apparatus that stimulates the auricles 110 by using the plurality of contacts 102. This ear stimulating apparatus 100M has a mechanism for an operation of thoroughly rubbing the entire auricles 110 or an operation of moving the contacts 102 to deform the auricles 110. As shown in FIG. 19, the ear stimulating apparatus 100M of the second embodiment stimulates the auricles 110 by performing at least an operation of rubbing the auricles 110 in the up and down direction (reciprocating operation in the arrow B direction of FIG. 19) in order to increase the blood flow of a human face or the like. As one example, as shown in FIG. 19, the ear stimulating apparatus 100M of the second embodiment performs an operation of twisting the auricles 110 (rotation operation in the circular direction of the arrow A direction of FIG. 19), the operation of rubbing the auricles 110 in the up and down direction (reciprocating operation in the arrow B direction of FIG. 19), an operation of rubbing the auricles 110 in the front and back direction (reciprocating operation in the arrow C direction of FIG. 19), and an operation of interlocking the plurality of contacts 102 with each other and deforming the auricles 110 (operation in the arrow D direction of FIG. 19) separately or in appropriate combination to increase the blood flow of a human face or the like. It is thought that by stimulating the auricles 110 by these operations, the ear stimulating apparatus 100M of the second embodiment can thoroughly stimulate many acupressure points in the auricles 110 to enhance the parasympathetic nervous system. That is, the ear stimulating apparatus 100M of the second embodiment also not only directly presses and stimulates the acupressure points of the auricles 110 but also utilizes friction or deformation of the auricles 110 to indirectly stimulate the acupressure points of the auricles 110. The operation of rubbing the auricles 110 in the up and down direction (reciprocating operation in the arrow B direction of FIG. 19) and the operation of rubbing the auricles 110 in the front and back direction (reciprocating operation in the arrow C direction of FIG. 19) are the directions substantially parallel to the front surfaces of the auricles 110.

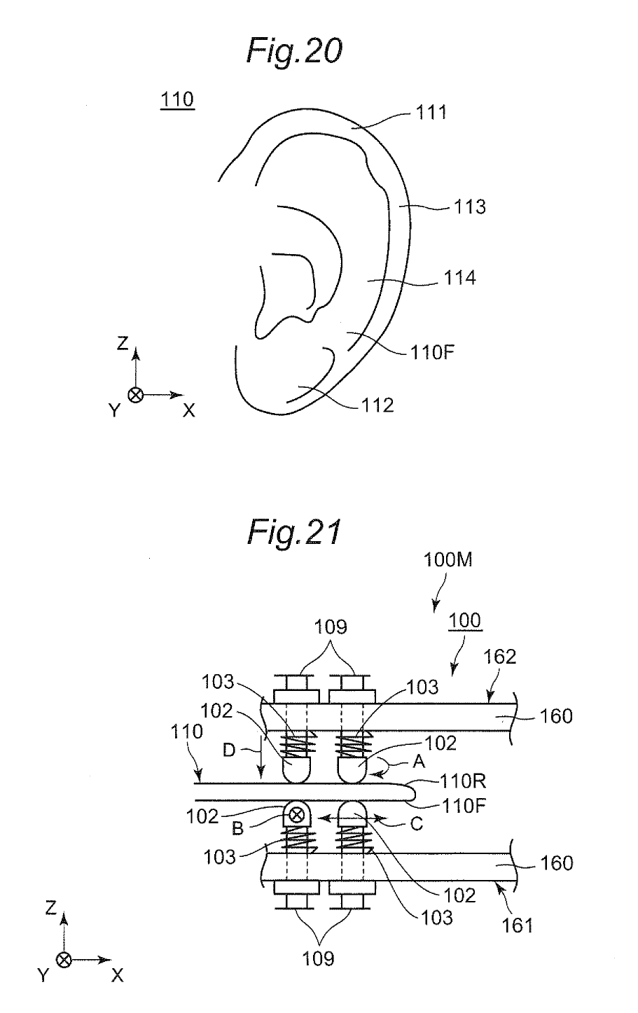

As shown in FIG. 20, each of the auricles 110 includes the apex auriculae 111 of the upper part, the earlobe 112 of the lower part, the helix 113, and the antihelix 114 of the center part. The ear stimulating apparatus 100M of the second embodiment stimulates the ear by bringing the four contacts 102 into contact with each of the front and back sides 110F and 110R of each auricle 110 and moving these contacts 102 in a state where the ear stimulating apparatus is put on parts of the auricles 110. These contacts 102 are desirably arranged on the acupressure points of each auricle 110. However, the contacts 102 are only required to be arranged to cover the region ranging from the periphery of the apex auriculae 111 of the upper part of each auricle 110 to the earlobe 112 of the lower part of each auricle 110, the region of 50 mm or more and 70 mm or less along the helix 113 or the antihelix 114.

In the ear stimulating apparatus 100M of the second embodiment, as one example, the arrangement, the number, or the like of the contacts 102, or the configuration, the operation, and the like of the ear stimulating apparatus may be similar to the ear stimulating apparatuses 100, 100a, and 100b of the first embodiment.

As shown in FIG. 21, the ear stimulating apparatus 100M also includes elastic bodies 103 such as springs for applying the force toward the auricles 110 to the contacts 102, first pulleys 109 that drive and forward/reversely rotate the contacts 102, and belts 104 that drive and forward/reversely rotate the first pulleys 109 in cases 160 of first units 161 or second units 162 as one example of the first transfer member 90. The first transfer member 90 transfers the force from the actuator 106 to the contacts 102. The elastic bodies 103 are arranged between the case 150 and leading ends of the contacts 102 so as to bias the contacts 102 with respect to the case 160 in such a manner that the contacts 102 can always exert the force toward the auricle 110.

It should be noted that a case where the contacts 102 are respectively moved by each actuator 106 will be illustrated in the following description. However, the plurality of contacts 102 may be coupled to be interlocked with each other as a mechanism, and by driving one contact 102 by one actuator 106 and interlocking the driven contact 102 with the other contacts 102 as a mechanism, all the contacts 102 may be moved in a similar manner. Thereby, the ear stimulating apparatus 100M can be realized to be inexpensive and lightweight.

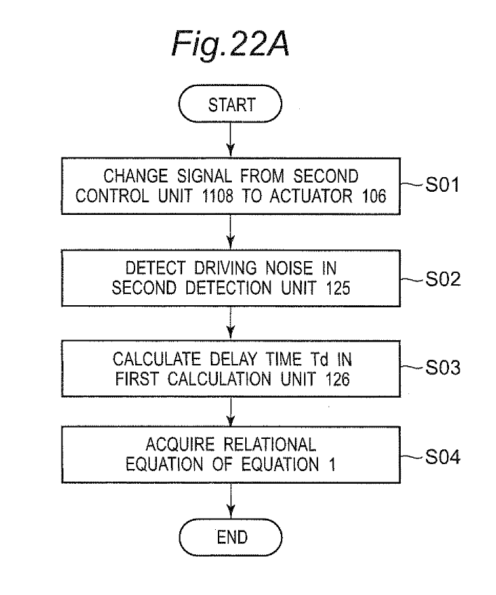

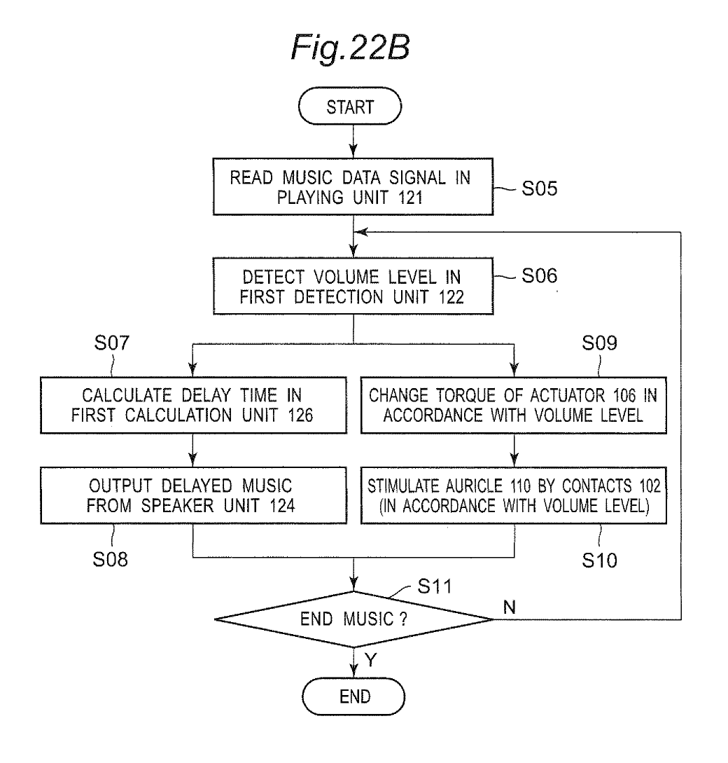

Successively, an ear stimulating method in the second embodiment will be described with reference to flowcharts of FIGS. 22A and 22B.

Firstly, a preparation operation (delay time calculation operation) will be described with reference to FIG. 22A.

When the stimulation to the auricles 110 by using the ear stimulating apparatus 100M is started by a switch or the like (not shown), the input signal (such as voltage or electric current) from the second control unit 1108 to the actuators 106 is firstly changed within an actually using range (step S01).

Successively, the driving noise of the first transfer member 90 is detected by using the second detection unit 125 (step S02).

Successively, the delay time “Td1” serving as a time difference between the time of start of changing the signal based on the input from the second control unit 1108 in step S01 and the time of detection of the driving noise by the second detection unit 125 in step S02 is calculated in the first calculation unit 126 (step S03).

By this processing operation of step S03, a relationship (relational equation) shown in Equation 1 below is acquired in the first calculation unit 126 and stored in a memory unit (step S04). The following relational equation of Equation 1 is an equation that represents a relationship between the input signal “fact” (such as voltage or electric current) to the actuator 106, the corresponding torque “τact” of the actuator 106, and the delay time “Td1”. In Equation 1, “G” denotes a function of the torque “τact” of the actuator 106 and the delay time “Td1” (Td1=G (τact)), and “F” is a function of the input signal “Iact” of the actuator 106 and the torque “τact” of the actuator 106 (τact=F (Iact)).

Td1=G(F(Iact)) (Equation 1)

It should be noted that the processing of step S01 to step S04 is processing of calculating the delay time “Td1” after acquiring the relational equation of calculating the delay time “Td1” which is unique for the first transfer member 90. Therefore, for example, the processing of step S01 to step S04 may be performed at the time of factory shipment, the relational equation of Equation 1 for calculating the delay time may be acquired in the first calculation unit 126 and stored in the memory unit, and for each use, only the processing of calculating the delay time in the first calculation unit 126 may be performed based on the input signal and the relational equation of Equation 1 stored in the first calculation unit 126.

Next, a processing operation when the user uses the ear stimulating apparatus 100M will be described.

Firstly, for example, when the stimulation to the auricles 110 by using the ear stimulating apparatus 100M is started by the switch or the like (not shown), the playing unit 121 reads the music data to be played from the first memory unit 129 (step S05).

Successively, the volume level of the music is detected in the first detection unit 122 such as a microphone based on the amplitude of the music data read by the playing unit 121 (step S06).

In the ear stimulating apparatus 100M of the second embodiment, as one characteristic, the magnitude of the torque (drive) by the actuator 106 is changed by the second control unit 1108 based on the volume level of the music to be played detected in the first detection unit 122. That is, in the ear stimulating apparatus 100M of the second embodiment, in a case where the first detection unit 122 detects that the volume level of the music to be played by the playing unit 121 is high, it is determined that larger driving noise does not exert a great influence, so that the torque is increased in the second control unit 1108. Meanwhile, in a case where the first detection unit 122 detects that the volume level of the music to be played by the playing unit 121 is low, it is determined that the influence of the driving noise is great, so that the torque is decreased in the second control unit 1108. In such a way, the ear stimulating apparatus 100M of the second embodiment has one characteristic that the magnitude of the torque (drive) by the actuator 106 is automatically changed in the second control unit 1108 based on the volume level of the music to be played. Specifically, in a case where the first detection unit 122 detects that the volume level of the music is higher than a threshold value, in order to strengthen the movement of the contacts 102, a torque signal inputted from the second control unit 1108 to the actuator 106 is set to be more than a predetermined value (preliminarily determined value) in the second control unit 1108. In a case where the first detection unit 122 detects that the volume level of the music is the threshold value or less, in order to weaken the movement of the contacts 102, the torque signal inputted from the second control unit 1108 to the actuator 106 is set to be less than the predetermined value in the second control unit 1108 (step S09). By such control, in a case where the volume level of the music to be played is high, the movement of the contacts 102 can be strengthened and the driving noise can be increased. Thus, even with strong stimulation, discomfort feeling of the user due to the driving noise can be reduced. Conversely, in a case where the volume level of the music to be played is low, the movement of the contacts 102 can be weakened and the driving noise can be reduced. As a result, by making the movement of the contacts 102 stronger or weaker, comfortable stimulation to the auricles 110 in accordance with the volume level of the music can be provided (step S10).

However, after output of the input signal from the second control unit 1108 till generation of the driving noise, the transfer delay is generated due to the influence of communications and transfer through the mechanism of the first transfer member 90.

Thus, in the ear stimulating apparatus 100M of the second embodiment, as another characteristic, by delaying play of the music for the delay time “Tds” serving as the sum of the delay time “Td2” of delay due to the communications and the delay time “Td1” of delay due to the first transfer member 90, the magnitude of the driving noise and the volume level of the music are synchronized.

Specifically, after step S06, based on the signal of the music data to be played detected in the first detection unit 122 and the corresponding input signal of each actuator 106, the delay times “Td1” and “Td2” and the delay time “Tds” of the sum are calculated in the first calculation unit 126 (step S07). Specifically, based on the input signal of each actuator 106 corresponding to the relational equation acquired in step S04 and Equation 1 described above, the delay time “Td1” is calculated in the first calculation unit 126. Based on a signal of the music data to be played detected in the first detection unit 122 and acquired in step S06 and Equation 3 to be described later, the delay time “Td2” is calculated in the first calculation unit 126. After that, the delay time “Tds” serving as the sum of the delay time “Td1” and the delay time “Td2” is calculated in the first calculation unit 126.

Successively, the play of the music to be played by the playing unit 121 is delayed by the first generation unit 123 for the delay time “Tds” calculated in the first calculation unit 126, and the delayed music is outputted from the speaker units 124 (step S08).

By such processing, the wearer (user) of the ear stimulating apparatus 100M of the second embodiment can receive the stimulation to the auricles 110 while listening to music by the contacts 102 whose drive is changed to be stronger or weaker in accordance with the music, without caring about the driving noise.

In the ear stimulating apparatus 100M of the second embodiment, a series of flows from step S06 of detecting the volume level to steps S07 to S08 of delaying the music and steps S09 to S10 of changing the torque are repeated until the music is stopped (step S11). steps S07 to S08 of delaying the music and steps S09 to S10 of changing the torque may be processed separately from each other and may be processed at the same time or in a time series.

Specific processing in step S09 will be described.

In the second control unit 1108, the relational equation of the torque “τact” of the actuator 106 corresponding to the volume level “Sound” detected in the first detection unit 122 is stored in the memory unit as Equation 2 below. “H” denotes a function of the torque “τact” of the actuator 106 and the volume level “Sound”. The torque “τact” is calculated in the second control unit 1108 with the volume level “Sound” detected in the first detection unit 122 and Equation 2. With the torque “τact” calculated in the second control unit 1108, Iact=F′ (τact) (wherein F′ is an inverse function of F) is calculated in the second control unit 1108, and the calculated input signal “Iact” of each actuator 106 is inputted to each actuator 106 by the second control unit 1108.

τact=H (Sound) (Equation 2)

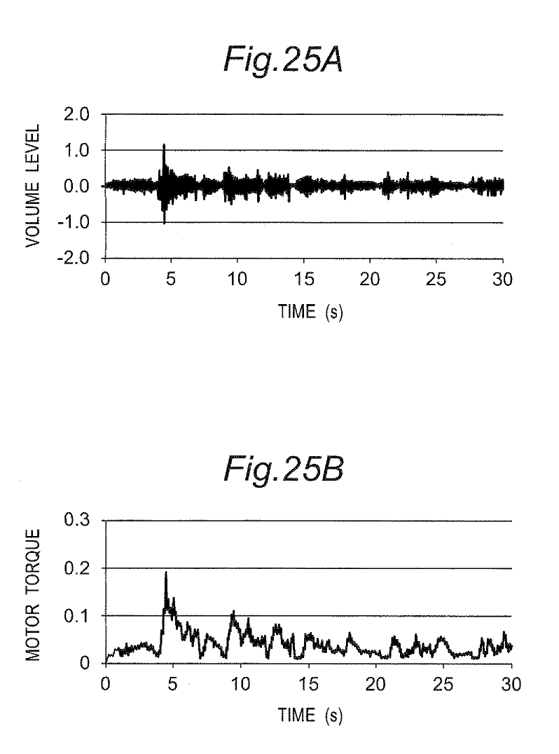

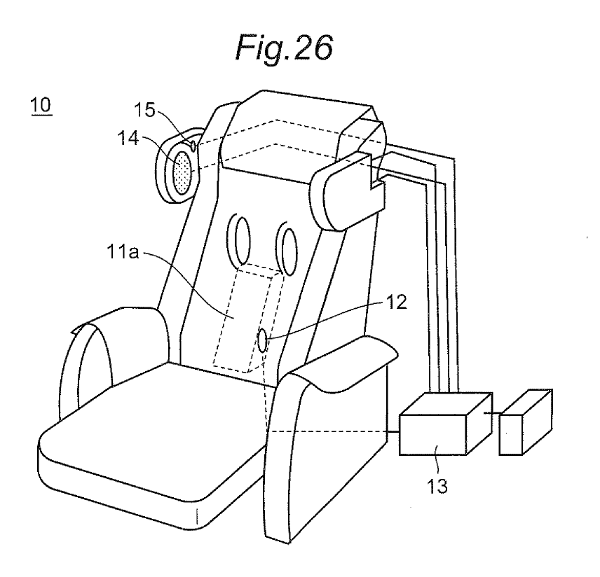

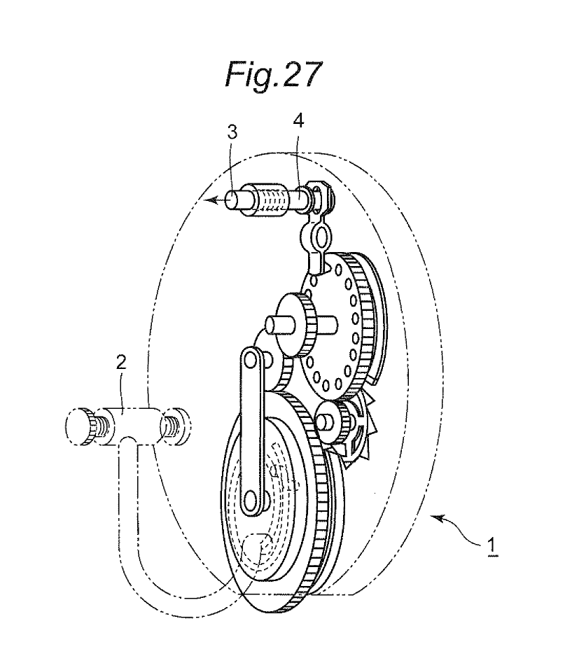

As one example, FIG. 25A shows a graph of a relationship between the volume level and time, and FIG. 25B shows a graph of a relationship between the torque and the time. When the volume level is high, the torque is also large. Conversely, when the volume level is low, the torque is also small.

Specific processing in step S07 will be described.

The delay time “Td2” relating to the music to be calculated in the first generation unit 123 is calculated by Equation 3 below from Equation 1 and Equation 2 with the volume level “Sound” detected in the first detection unit 122.

Td2=G(H(Sound)) (Equation 3)

Therefore, in the first generation unit 123, the delay time “Td2” can be calculated by the volume level “Sound” detected in the first detection unit 122 and Equation 3. After that, in the first calculation unit 126, the delay time “Tds” serving as the sum of the delay time “Td1” and the delay time “Td2” is calculated.

It should be noted that the ear stimulating apparatus 100M to be worn on the auricles 110 may be a type to be worn only on one ear or a type to be worn on left and right ears. In a case where the ear stimulating apparatus 100M is worn on the left and right auricles 110, the music of one playing unit 121 is shared by both the ears.

It should be noted that the speaker unit 124 may be inserted into the ear hole as an earphone type or may cover the auricle 110 as a headphone type. As the earphone type, the speaker unit also functions as an earplug. Thus, the influence of the driving noise can be further reduced, so that the speaker unit can also serve as a noise-cancelling type earphone. As the headphone type, there is no need for corresponding to an ear hole shape which differs largely between individuals, so that the sound can be easily generated.

It should be noted that although the first transfer member 90 is composed of the plurality of gears, other transfer mechanisms or members such as a timing belt, links, or cams may also be used. With the timing belt as the transfer mechanisms or the member, the operations of the contacts 102 can be more delicate, weight of the entire ear stimulating apparatus 100M can be reduced, or transfer efficiency can be improved. The delay time differs between the configurations of the mechanisms or the members. Thus, the delay time is desirably measured and set for each of the mechanisms or the members.

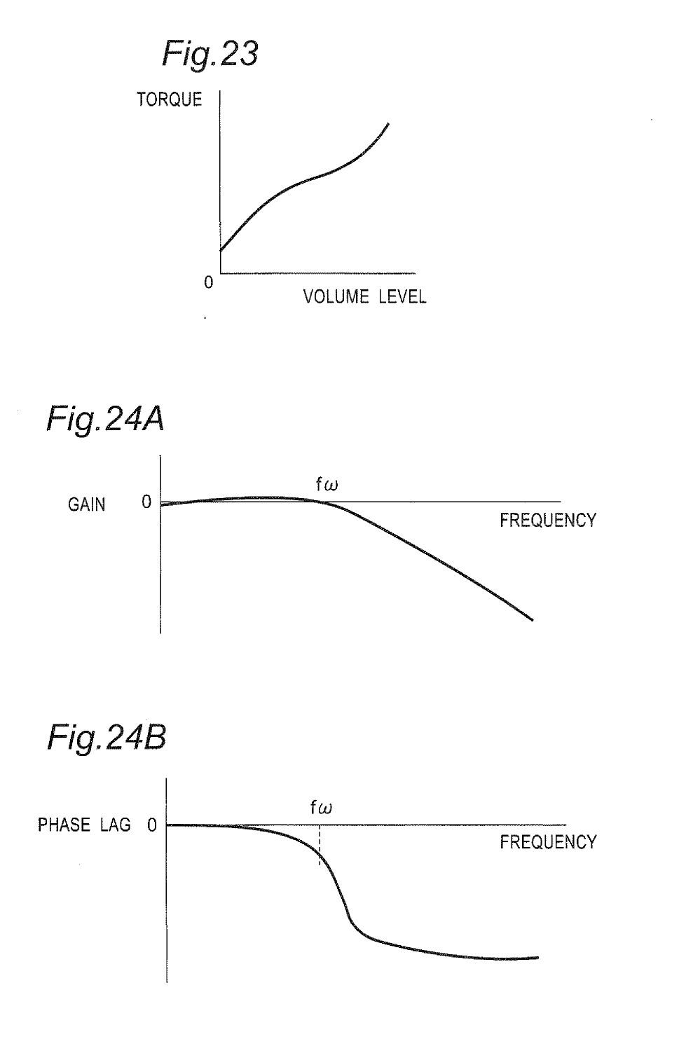

It should be noted that the function of the volume level of the music detected in the first detection unit 122 and the torque serving as the input signal of the actuator 106 is desirably in a relationship of monotonically increase as shown in FIG. 23. By such a relationship, the ear stimulation to be made stronger or weaker in accordance with the volume level of the music can be provided.

It should be noted that as shown in FIG. 23, when the volume level of the music is zero, the torque is desirably not zero. In such a way, even when the volume level is zero, the ear stimulation to the auricle 110 can be provided.

It should be noted that in a case where all the operations of the actuator 106 follow up changes in the volume level of the music, the user possibly feels troublesomeness in frequent changes of the operations. Therefore, for example, in order not to generate a change of a frequency fz (frequency of 3 Hz in the experiment of the inventors) or more which possibly causes discomfort feeling, when the electric signal is sent from the first detection unit 122 to the second control unit 1108, a lowpass filter 130 that cuts a signal at the frequency fz or more is desirably used.

In a case where not only the discomfort feeling but also a follow-up limit as a mechanism is considered, drive is desirably performed at a frequency which is smaller than a cut-off frequency fω in a Bode plot. The Bode plot is a plot graphing the relationship between gain or phase lag and the frequency shown in FIGS. 24A and 24B. That is, in a case where the follow-up limit as the mechanism is also considered, a lowpass filter 135 that cuts a signal at the cut-off frequency fω or more in the Bode plot graphing the gain or the phase lag and the frequency among signals sent from the first detection unit 122 to the second control unit 1108 is desirably arranged and used between the first detection unit 122 and the second control unit 1108. FIGS. 24A and 24B show the gain and the phase lag serving as logarithms of an amplitude ratio between an input signal and an output signal.

It should be noted that although music that the user of this apparatus desires may be played by the playing unit 121, preliminarily registered music may also be played. By using the preliminarily registered music, a type of the preliminarily registered music can be switched in accordance with a mode serving as a type of the ear stimulation preliminarily stored in the second control unit 1108. For example, when a piece of music with a slow-tempo in which a change in the volume level of the music is smooth is registered as a “relaxation mode (ear stimulation mode with small torque)” and a piece of aggressive music in which the change in the volume level of the music is quick is conversely registered as an “aggressive mode (ear stimulation mode with large torque)”, only by selecting modes by the user of this apparatus, different types of ear stimulations can be provided. By selecting a mode of the ear stimulation, the music that matches necessary ear stimulation can be played. Different types of ear stimulations are, for example, stimulations achieved by a single operation or combined operations selected from the operation of twisting the auricle 110, the operation of rubbing the auricle 110 in the up and down direction, the operation of rubbing the auricle 110 in the front and back direction, and the operation of interlocking the plurality of contacts 102 with each other and temporarily deforming the auricle 110. A plurality of different ear stimulation modes is stored in the second control unit 1108, and the playing unit 121 can select and play the music in accordance with the mode selected by the user.

It should be noted that the volume level of the music is detected from the signal of the music data in the first detection unit 122. However, power and a derivative value thereof may be calculated for each processing frame of the music, a bar duration may be calculated by determining a maximum value of an autocorrelation function of the derivative value, and the tempo may be detected from the bar duration and the be at number. By detecting the tempo, the ear stimulation that matches the rhythm of the music itself can be provided.

In the first detection unit 122, the volume level of the music is detected from the signal of the music data. However, a volume level of only deep bass sound or a volume level of a particular musical instrument may be detected. For this, analysis is performed in not only a time region but also a frequency region. In a case of the deep bass sound, the frequency of the sound is low. Thus, feel like the sound echoing inside a body can be obtained. When the contacts 102 are slowly moved to match the sound, gentle stimulation can be provided to the auricle 110. In a case of the particular musical instrument, by matching the musical instrument, an effect of gentle stimulation as well as the above description can be obtained. In a case where the music is of high pitched sound, the music is often such music that changes are relatively often generated. Thus, as being capable of providing aggressive movement of the contacts 102, various characteristics can be provided.

It should be noted that although the torque of the actuator 106 is related to the volume level in the second control unit 1108, displacement, rotation speed, or the like of the actuator 106 may be changed to control rotation. Thereby, rhythmical movement can be realized.

It should be noted that in the first calculation unit 126, the relationship between the input signal of the actuator 106 and the delay time “Td1” is a one-to-one relationship and the delay time “Td2” is changed in accordance with the input signal of the actuator 106 corresponding to the volume level. However, an average value of delay times “Td1” with respect to a plurality of input signals may be calculated in the first calculation unit 126 to have a fixed value of the delay time “Tds”, and delay for a fixed time (fixed value of the delay time “Tds”) may be generated in the first generation unit 123 without depending on the volume level. Thereby, the delay can be easily generated.

It should be noted that by using a switch capable of synthesizing the music or adjusting the tempo, the user can make the ear stimulation stronger or weaker or switch speed of the ear stimulation by himself/herself in conjunction with a type or the tempo of the music. Thereby, preference or mood of the user can be reflected in real time.

It should be noted that a sensor 136 such as a sphygmomanometer, a heart rate meter, or a thermometer may be installed in the earlobe, the ear hole, or the like. The actuator 106 may be controlled by the second control unit 1108 based on information detected by the sensor 136. For example, by the information from the sphygmomanometer, the heart rate meter, the thermometer, or the like the second control unit 1108 may determine whether or not a physical condition of the user is unfavorable based on threshold values, and in a case where the condition is unfavorable, an operation of weakening or stopping the ear stimulation or the like may be automatically performed.

According to the ear stimulating apparatus 100M of the second embodiment, an effect of stimulating the ear can be furthermore improved in comparison to the conventional example, and the influence of the driving noise can be reduced. That is, the wearer (user) of the ear stimulating apparatus 100M can receive the stimulation to the auricle (s) 110 while listening to the music by the contacts 102 whose drive is changed to be stronger or weaker in accordance with the volume level of the music without caring about the driving noise. By delaying the play of the music for the delay time “Tds”, the magnitude of the driving noise and the volume level of the music can be synchronized, so that the user can more reliably receive the stimulation to the auricle(s) 110 without caring about the driving noise.

By properly combining the arbitrary embodiment(s) or modification(s) of the aforementioned various embodiments and modifications, the effects possessed by the embodiment(s) or modification(s) can be produced.

The ear stimulating apparatus of the present invention is capable of further improving the effect of stimulating the ear in comparison to the conventional example, and is useful in medical or cosmetic fields in which blood flow circulation is facilitated.

Although the present invention has been fully described in connection with the embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An ear stimulating apparatus comprising:
first and second units arranged to clip on an auricle;
a plurality of contacts arranged in the first unit at least at positions where the contacts are configured to be brought into contact with a front side of the auricle; and
an actuator that moves the contacts in a longitudinal direction of the first unit.

2. The ear stimulating apparatus according to claim 1, further comprising:
contacts arranged in the second unit at least at positions where the contacts are configured to be brought into contact with a back side of the auricle.

3. The ear stimulating apparatus according to claim 1, wherein
a longitudinal size L of the first unit is 10 mm≦L≦20 mm.

4. The ear stimulating apparatus according to claim 1, wherein
the longitudinal direction of the first unit is an up and down direction of the auricle.

5. The ear stimulating apparatus according to claim 1, wherein
the actuator also moves the contacts in a direction crossing the longitudinal direction in addition to the longitudinal direction of the first unit.

6. The ear stimulating apparatus according to claim 2, wherein
the contacts in the first unit are arranged at least at three vertices of a triangle so as to be brought into contact with the front side of the auricle,
the contacts in the second unit are arranged at least at three vertices of a triangle so as to be brought into contact with the back side of the auricle in such a manner that at least one of the latter three vertices is placed between the two vertices among the vertices of the triangle of the first unit or in vicinity of a part between the two vertices, and
the actuator respectively moves the two contacts arranged at the two vertices of the first unit and the contact arranged at the one vertex of the second unit to a side of the auricle in synchronization, so as to deform the auricle into a V shape between the first unit and the second unit.

7. The ear stimulating apparatus according to claim 1, wherein
the contacts include four contacts arranged at four vertices of an isosceles trapezoid.

8. The ear stimulating apparatus according to claim 2, wherein
the contacts are arranged in the first unit and the second unit at positions where the contacts are configured to be brought into contact with the front side and the back side of the auricle, and
the actuator rotates the contacts of the first unit and the second unit in same phase.

9. The ear stimulating apparatus according to claim 2, wherein
the contacts are arranged in the first unit and the second unit at positions where the contacts are configured to be brought into contact with the front side and the back side of the auricle, and
the actuator rotates the contacts of the first unit and the second unit in phases opposite to each other.

10. The ear stimulating apparatus according to claim 2, wherein
at least three contacts are arranged in each of the first unit and the second unit at positions where the contacts are configured to be brought into contact with the front side or the back side of the auricle, and
in a state where the actuator moves one of the upper and lower contacts in each of the first unit and the second unit to the side of the auricle so as to clip on and hold the auricle, the actuator moves remaining contacts in the longitudinal direction of the first unit.

11. The ear stimulating apparatus according to claim 2, wherein
the contacts are arranged in the first unit and the second unit at positions where the contacts are configured to be brought into contact with the front side and the back side of the auricle, and
a frictional coefficient of leading ends of the contacts of the first unit is smaller than a frictional coefficient of a leading end of the contact of the second unit.

12. The ear stimulating apparatus according to claim 1, further comprising:
a playing unit that plays music; and
a second control unit that controls drive of the actuator based on a volume level or a tempo of the music played by the playing unit.

13. The ear stimulating apparatus according to claim 12, wherein
the second control unit strengthens the drive of the actuator in a case where the volume level of the music is high, and weakens the drive of the actuator in a case where the volume level of the music is low.

14. The ear stimulating apparatus according to claim 12, wherein
the second control unit changes torque of the actuator in accordance with the volume level or the tempo of the music.

15. The ear stimulating apparatus according to claim 12, further comprising:
a first detection unit that detects the volume level or the tempo of the music, wherein
the second control unit controls torque or rotation speed of the actuator in accordance with the volume level or the tempo of the music detected in the first detection unit.

16. The ear stimulating apparatus according to claim 12, wherein
the first unit further comprises a first transfer member that transfers a force from the actuator to the contacts, and
the second control unit calculates a delay time until a signal is transferred from the actuator to the first transfer member, delays the music for the delay time, and causes the playing unit to play the music.

17. The ear stimulating apparatus according to claim 15, further comprising:
a filter that cuts a signal at a frequency of 3 Hz or more sent from the first detection unit to the second control unit.

18. The ear stimulating apparatus according to claim 15, further comprising:
a filter that cuts a signal at a cut-off frequency of fω or more in a Bode plot graphing gain or phase lag and a frequency among signals sent from the first detection unit to the second control unit.

19. The ear stimulating apparatus according to claim 12, wherein
the second control unit stores a plurality of different ear stimulation modes, and
the playing unit selects and plays the music in accordance with the selected mode.

20. The ear stimulating apparatus according to claim 12, wherein
the ear stimulating apparatus is of a headphone type including two housings and a headband as a whole, and
the contacts, the actuator, the playing unit, and the second control unit are arranged in the housings.
